(19) United States
(12) Patent Application Publication
(10) Pub. No.: US 2023/0325949 A1
(43) Pub. Date: Oct. 12, 2023

(54) INFORMATION PROCESSING SYSTEM

(71) Applicant: SONY GROUP CORPORATION, Tokyo (JP)

(72) Inventor: Hideo NAGASAKA, Tokyo (JP)

(73) Assignee: SONY GROUP CORPORATION, Tokyo (JP)

(21) Appl. No.: 18/041,856

(22) PCT Filed: Jul. 27, 2021
(86) PCT No.: PCT/JP2021/027669

§ 371 Date: Feb. 16, 2023

(30) Foreign Application Priority Data
Sep. 2, 2020 (JP) 2020-147910

(51) Int. Cl. G06Q 10/02; G06Q 50/14

(52) U.S. Cl. CPC G06Q 50/14; G06Q 10/025

(57) ABSTRACT

An information processing system includes a custom tour creation system and a tour support system. The custom tour creation system creates a custom tour by incorporating optional information input from a user into a master schedule including a plurality of spots, a standard time of stay at each spot, and a standard route between the spots (SP). The tour support system monitors a progress of the custom tour being executed, and presents tour support information based on the progress to a user to support an action of the user.

### FIELD

The present invention relates to an information processing system.

### BACKGROUND

Due to the influence of digitalization, various information becomes available, and various travel plans can be provided. However, since there is so much information out there, more people are bothered by decision making.

### CITATION LIST

### Non Patent Literature

Non Patent Literature 1: JTB Tourism Research & Consulting Co., “Evolving and Expanding Japanese Domestic Travel (2019)”, [online], Sep. 25, 2019, [searched on May 29, 2020], Internet <URL: https://press.jtbcorp.jp/jp/2019/09/20190925-sokenkokunairyokou.htm>

### SUMMARY

### Technical Problem

A personal travel plan tends to be a collection of points selected from a catalog, and is inconsistent as a whole. There is also an option of a package tour, but since the meeting place is determined and many people take action, the action and time are limited. Traveling in a group is also undesirable from the viewpoint of prevention of population infection. The need for individual travel is also increasing, and there is a demand for a travel service platform capable of presenting a custom tour that does not impair the degree of freedom of individual travel while maintaining the convenience of a package tour.

Therefore, the present disclosure proposes an information processing system capable of presenting a custom tour that does not impair the degree of freedom of individual travel while maintaining the convenience of a package tour.

### Solution to Problem

According to the present disclosure, an information processing system is provided that comprises: a custom tour creation system that creates a custom tour by incorporating optional information input from a user into a master schedule including a plurality of spots, a standard time of stay at each spot, and a standard route between the spots; and a tour support system that monitors a progress of a custom tour being executed, presents tour support information based on the progress to the user, and supports an action of the user.

### BRIEF DESCRIPTION OF DRAWINGS

FIG. 1 is a schematic diagram of a travel service platform.

FIG. 2 is a schematic diagram of an information processing system.

FIG. 3 is a diagram illustrating an example of a tour information screen displayed on a user terminal.

FIG. 4 is a diagram illustrating an example of a process of creating a custom tour.

FIG. 5 is a conceptual diagram of a custom tour CT.

FIG. 6 is an explanatory diagram of a spot.

FIG. 7 is an explanatory diagram of a route guide.

FIG. 8 is an explanatory diagram of a first mode of in-spot assistance.

FIG. 9 is an explanatory diagram of a second mode of the in-spot assistance.

FIG. 10 is an explanatory diagram of the second mode of the in-spot assistance.

FIG. 11 is an explanatory diagram of the second mode of the in-spot assistance.

FIG. 12 is an explanatory diagram of the second mode of the in-spot assistance.

FIG. 13 is an explanatory diagram of time keeping.

FIG. 14 is a conceptual diagram of a route change.

FIG. 15 is an explanatory diagram of a route guide.

FIG. 16 is a conceptual diagram of a custom tour including a time-limited event.

FIG. 17 is an explanatory diagram of a route guide in consideration of the time-limited event.

FIG. 18 is an explanatory diagram of the route guide in consideration of the time-limited event.

FIG. 19 is a diagram illustrating an example of a master schedule creation screen.

FIG. 20 is an explanatory diagram of actual schedule extraction processing.

FIG. 21 is an explanatory diagram of actual schedule processing.

FIG. 22 is an explanatory diagram of spot introduction image assignment processing.

FIG. 23 illustrates an image of a master schedule creation UI.

FIG. 24 is an explanatory diagram of event extraction processing.

FIG. 25 is an explanatory diagram of a master schedule including label information.

FIG. 26 is an explanatory diagram of special event extraction processing.

FIG. 27 is an explanatory diagram of schedule adjustment based on a special event.

FIG. 28 is an explanatory diagram of the schedule adjustment based on the special event.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Note that the description will be given in the following order.
[1. Overview of Travel Service Platform]
[2. Configuration of Information Processing System]
[3. Overview of Custom Tour]
   [3-1. Image of Tour Plan to Be Provided]
   [3-2. Creation of Custom Tour]
   [3-3. Experience Image of Custom Tour]
   [3-4. Description of Spot]
[4. Support of User’s Action]
   [4-1. Route Guide]
   [4-2. First Mode of In-Spot Assistance]
   [4-3. Second Mode of In-Spot Assistance]
   [4-4. Time Keeping]
   [4-5. Route Change]
   [4-6. Time-Limited Event]
   [4-7. Route Change Based on Priority Information]
   [4-8. Change in Arrival Time at Reserved Hotel and Cancellation]
   [4-9. Change in Arrival Time at Reserved Restaurant and Cancellation]
[5. Creation of Master Schedule]
   [5-1. Extraction of Actual Schedule]
   [5-2. Actual Schedule Processing]
   [5-3. Assignment of Picture to Spot]
   [5-4. Incorporation of Event]
   [5-5. Incorporation of Label Information]
[6. Effects]

### 1. Overview of Travel Service Platform

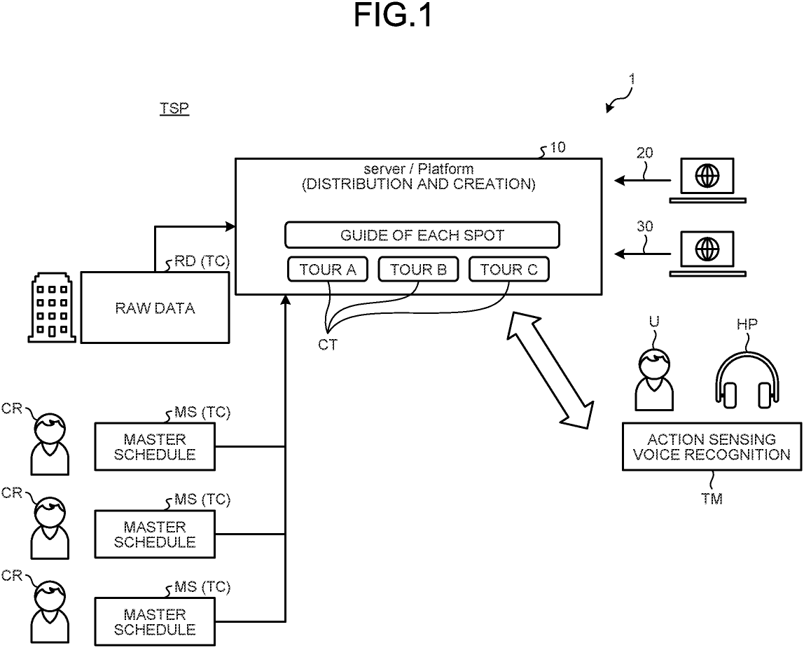

FIG. 1 is a schematic diagram of a travel service platform TSP.

The travel service platform TSP is a platform for providing and processing a travel content TC as UGC (User Generated Contents). The travel content TC is created and processed using an information processing system 1. A creator CR uploads the travel content TC such as a master schedule MS and raw data RD to a core system 10. A user U creates and executes a custom tour CT using the master schedule MS and the raw data RD provided by the creator CR.

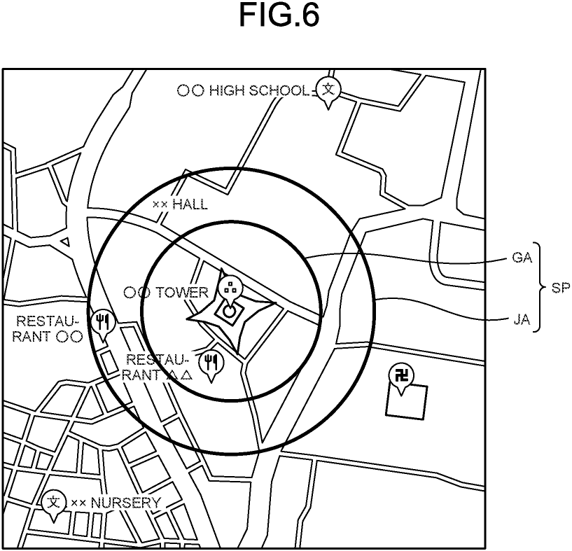

The master schedule MS is a rough tour schedule. The master schedule MS includes a plurality of spots SP (see FIG. 6) to be visited, a standard time of stay at each spot SP, and a standard route between the spots SP. The user U inputs information (information insufficient in the master schedule MS, information for changing the master schedule MS to the preference of the user U, and the like) necessary for completing the master schedule MS as a tour as optional information. The user U creates a desired custom tour CT by incorporating the optional information into the master schedule MS.

The spot SP means a place and an event that the creator CR wants the user U to visit. In addition to what is known as a tourist spot, the spot SP includes an event such as a festival or a firework, a place with a good view, a hotel, a restaurant, a place where a work such as an animation or a cartoon is set, a place where a character in the work or the author himself or herself is related, and the like. The raw data RD is a travel content TC scheduled to be incorporated into and used in the master schedule MS. The raw data RD includes a position of the spot SP, a range of the spot SP, spot introduction information introducing the spot SP, a sub-tour held in the spot SP, and the like.

The action of the user U during the tour is detected by a user terminal TM. The user terminal TM is a mobile terminal held by the user U. As the user terminal TM, a smartphone, a tablet terminal, a notebook personal computer, and the like are used. The core system 10 estimates the situation in which the user U is placed on the basis of sensor information detected by the user terminal TM. The core system 10 appropriately provides the user U with information suitable for the situation in which the user U is placed.

The input of information (optional information, schedule change information, and the like) from the user U to the information processing system 1 and the output of information (notification, warning, proposal, and the like) from the information processing system 1 to the user U are performed via the user terminal TM and an input and output device HP connected to the user terminal TM. As the input and output device HP, for example, a wearable device such as a smart watch or headphones is used. The smart watch enables a gesture input operation via a touch panel. The smart watch can also function as the user terminal TM by being directly connected to the mobile network. The headphone enables an audio input and output operation via a microphone.

The core system 10 appropriately corrects the schedule of the custom tour CT on the basis of the progress of the custom tour CT, the change information from the user U, and the like. The core system 10 makes hotel and restaurant reservations, changes, and cancellations via a hotel reservation system 20 and a restaurant reservation system 30.

### 2. Configuration of Information Processing System

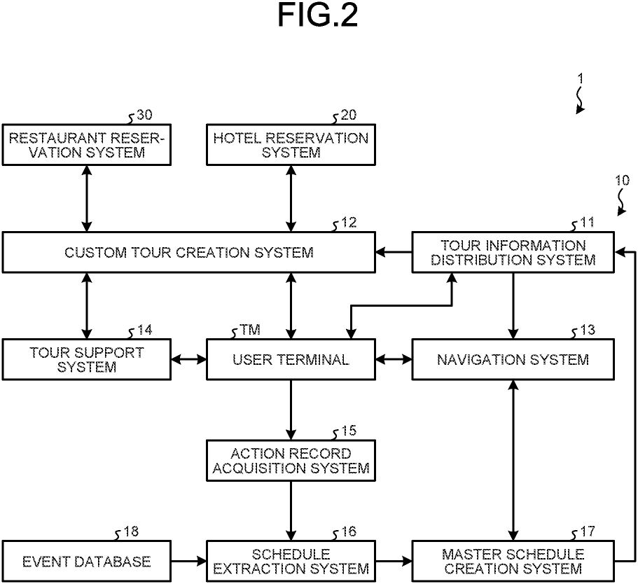

FIG. 2 is a schematic diagram of the information processing system 1.

The information processing system 1 includes the core system 10, the hotel reservation system 20, and the restaurant reservation system 30.

The core system 10 includes, as systems for creating and executing the custom tour CT, a tour information distribution system 11, a custom tour creation system 12, a navigation system 13, and a tour support system 14. The core system 10 also includes, as systems for creating the master schedule MS, an action record acquisition system 15, a schedule extraction system 16, a master schedule creation system 17, and an event database 18.

The tour information distribution system 11 stores the master schedule MS and the raw data RD. The tour information distribution system 11 stores information of the custom tour CT obtained by processing the master schedule MS. The tour information distribution system 11 executes the custom tour CT on the basis of the schedule defined in the custom tour CT. The tour information distribution system 11 monitors the action of the user U during the tour and generates appropriate information based on the situation in which the user U is placed.

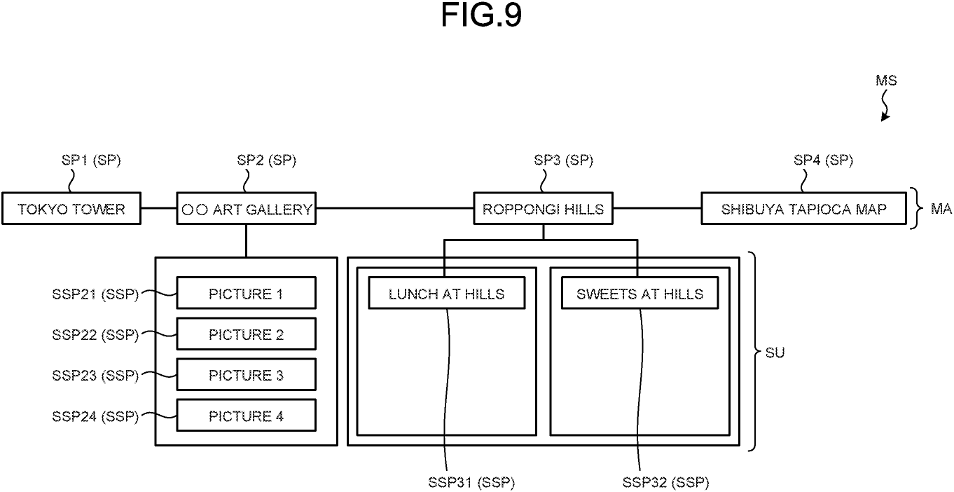

The custom tour creation system 12 creates the custom tour CT by incorporating the optional information input from the user U into the master schedule MS. The optional information includes, for example, a point of departure of the user U, a desired departure time, a plurality of spots SP to be visited, a scheduled time of stay at each spot SP, a method of transportation between the spots SP, desired conditions of a hotel, desired conditions of a restaurant, and the like. In a case where the master schedule MS includes a spot SP in which a plurality of selectable sub-schedules SU (see FIG. 9) is registered, information about which sub-schedule SU is selected is also included in the optional information.

The custom tour creation system 12 appropriately changes the schedule of the custom tour CT being executed in accordance with the situation where the user U is placed. For example, due to the input of change information related to a schedule change from the user U during the execution of the custom tour CT, the custom tour creation system 12 changes the schedule of the custom tour CT after the input time of the change information on the basis of the change information Even if the change information is not input from the user U, the custom tour creation system 12 can change the schedule of the custom tour CT in accordance with the progress of the custom tour CT being executed.

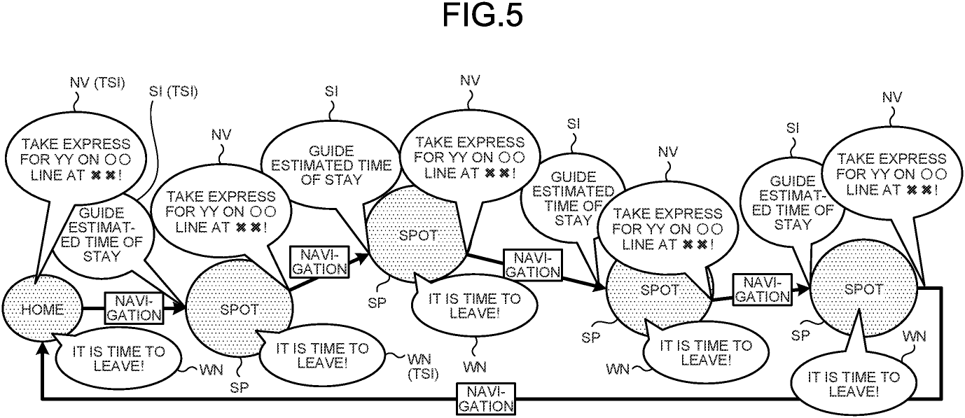

The navigation system 13 generates navigation information NV (see FIG. 5) indicating a method of transportation between two points. For example, the navigation system 13 generates the navigation information NV to a destination due to the acquisition of travel start information of the user U. The travel start information is generated by the tour support system 14 on the basis of the position information of the user U during the tour. The navigation system 13 is also used as a means for specifying the route of the user U after the end of the tour.

The tour support system 14 monitors the progress of the custom tour CT being executed. For example, the tour support system 14 estimates the current status (current position, travel status, and the like) of the user U on the basis of sensor information (information such as acceleration and angular velocity information detected by a motion sensor, and position information based on global positioning system (GPS) data) detected by the user terminal TM. The tour support system 14 compares the current status of the user U with the schedule of the custom tour CT, and determines the progress of the custom tour CT being executed. The tour support system 14 is provided, for example, in the user terminal TM, but may be provided in a server outside the user terminal TM.

The tour support system 14 presents tour support information TSI (see FIG. 5) based on the progress to the user U to support the action of the user U. The tour support information TSI includes, for example, the navigation information NV between the spots SP, the information related to the schedule for each spot SP, spot introduction information SI for each spot SP, the progress of the custom tour CT, a warning related to the travel schedule between the spots SP, and a proposal related to a change in the schedule of the custom tour CT. For example, the tour support system 14 notifies the user U of the tour support information TSI by voice. The tour support system 14 detects the response of the user U to the tour support information TSI on the basis of the voice of the user U or the gesture to the wearable device worn by the user U.

The action record acquisition system 15 acquires an action record during the tour stored in the user terminal TM. The action record includes, for example, various types of information associated with GPS data.

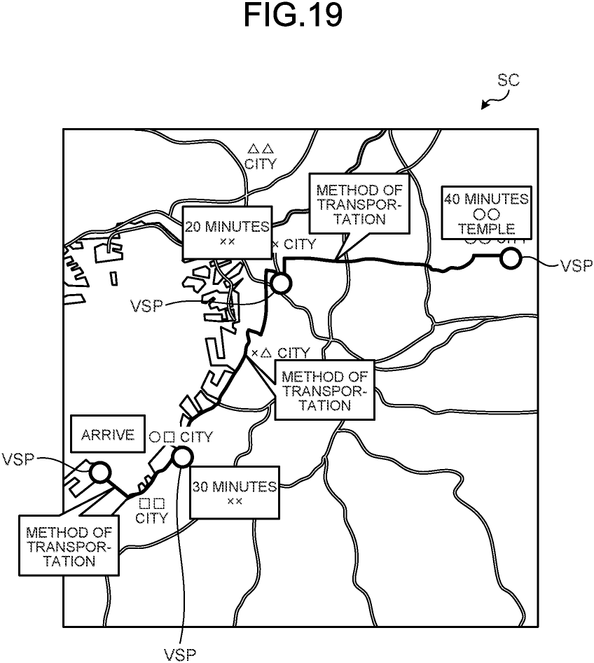

The schedule extraction system 16 extracts an actual schedule including a plurality of visit spots VSP (see FIG. 19), a time of stay at each visit spot VSP, and a route between the visit spots VSP from the action record during the tour. The actual schedule is a base of the master schedule MS newly created by the creator CR.

For example, the schedule extraction system 16 extracts the actual schedule on the basis of an action record associated with the GPS data. The schedule extraction system 16 acquires information such as a traffic line, a travel time, a travel speed, and a time of stay on the basis of the GPS data. A place with a long time of stay is often recognized as an important spot. Therefore, the schedule extraction system 16 extracts the visit spot VSP on the basis of the information about the time of stay at each place.

The action record includes, for example, captured data captured during the tour. In a case where a famous site, a historic site, or the like is included in the subject, the schedule extraction system 16 can specify the visit spot VSP on the basis of the captured content.

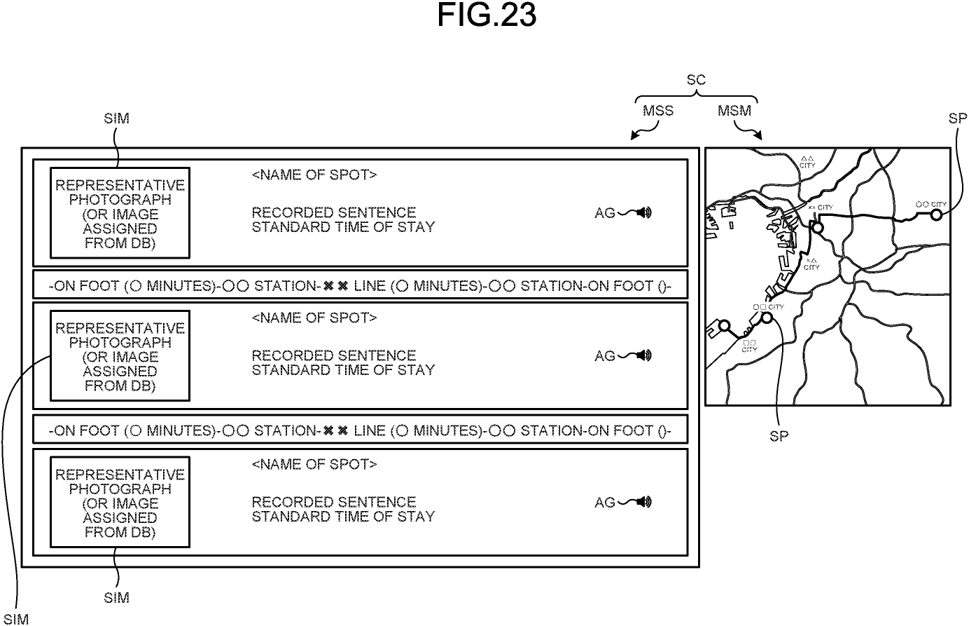

The master schedule creation system 17 determines a plurality of spots SP to be visited, a standard time of stay at each spot SP, and a standard route between the spots SP on the basis of correction information added by the creator CR to the actual schedule, and creates the master schedule MS. The master schedule creation system 17 registers the spot introduction image SIM (see FIG. 23) in the master schedule MS for each spot SP.

The event database 18 stores event information of various national and international events held throughout the year. The event information includes an event venue and the date and time of an event.

The hotel reservation system 20 makes a reservation for a hotel that meets the desired conditions. The restaurant reservation system 30 makes a reservation for a restaurant that meets the desired conditions. The desired conditions of the hotel and the desired conditions of the restaurant are input to the master schedule MS as optional information.

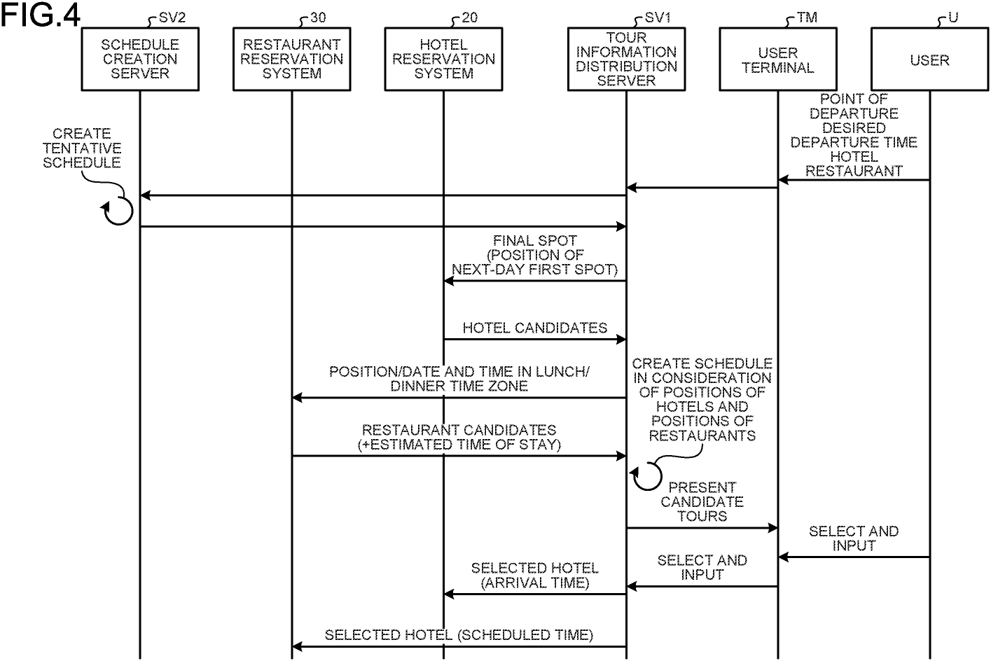

Individual components constituting the information processing system 1 may be distributed and arranged in one or more servers. For example, the tour information distribution system 11 is arranged in a tour information distribution server SV1 (see FIG. 4). The custom tour creation system 12 is arranged in a distributed manner in the tour information distribution server SV1 and a schedule creation server SV2 (see FIG. 4).

The schedule creation server SV2 has a function of creating a tentative schedule in consideration of the point of departure and the desired departure time among the functions of the custom tour creation system 12. The tour information distribution server SV1 has the remaining functions that are not performed by the schedule creation server SV2 among the functions of the custom tour creation system 12. Specifically, the tour information distribution server SV1 has a function of creating the custom tour CT by incorporating a hotel and a restaurant into the tentative schedule created by the schedule creation server SV2, and a function of appropriately changing the custom tour CT or proposing a change of the custom tour CT being executed in accordance with the situation in which the user U is placed.

### 3. Overview of Custom Tour

### 1. Image of Tour Plan to Be Provided]

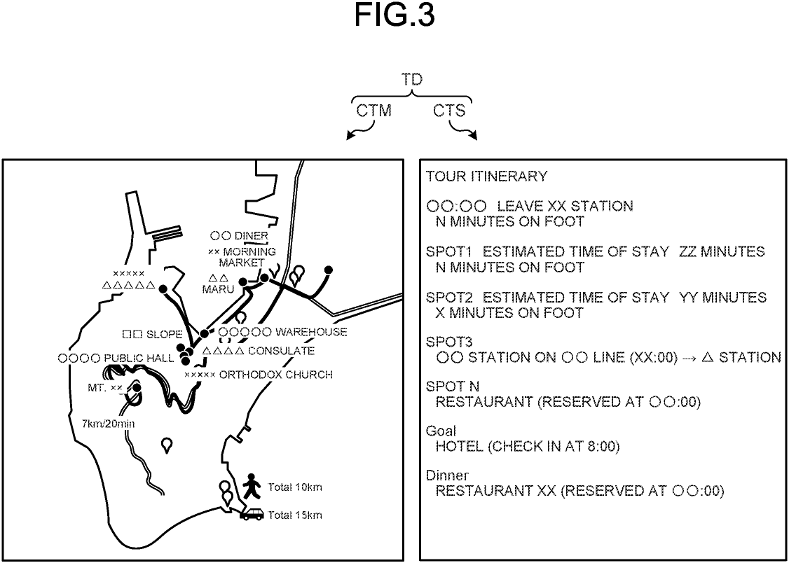

FIG. 3 is a diagram illustrating an example of a tour information screen TD displayed on the user terminal TM.

The schedule of the custom tour CT can be checked on the tour information screen TD. A map CTM and a tour schedule CTS are displayed on the tour information screen TD. The position and name of each spot SP are displayed on the map CTM. In the map CTM, a travel route is displayed by a line connecting the spots SP. In the tour schedule CTS, a point of departure, a scheduled departure time, a name of a spot SP, a method of transportation between the spots SP, a scheduled time of stay at each spot SP, a name of a restaurant, a scheduled visit time of a restaurant, a name of a hotel, a scheduled check in time of a hotel, and the like are displayed.

### 2. Creation of Custom Tour]

FIG. 4 is a diagram illustrating an example of a process of creating the custom tour CT. Note that the tour information distribution system 11 described above is arranged in the tour information distribution server SV1. The custom tour creation system 12 is arranged in a distributed manner in the tour information distribution server SV1 and the schedule creation server SV2.

First, the user U accesses the tour information distribution server SV1 via the user terminal TM. The user U selects a desired master schedule MS from a plurality of master schedules MS stored in the tour information distribution server SV1. The selection of the master schedule MS may be performed on the basis of recommendation information provided by the tour information distribution server SV1. For example, when the user U inputs a destination, a spot, a number of days, a budget, or the like to the tour information distribution server SV1, a master schedule matching the input information of the user U is provided to the user U as the recommended information. The user U inputs optional information to the master schedule MS via the user terminal TM. The optional information includes a point of departure, a desired departure time, desired conditions of a hotel, desired conditions of a restaurant, and the like.

The schedule creation server SV2 creates a tentative schedule in which the point of departure and the desired departure time are incorporated into the master schedule MS.

The tour information distribution server SV1 transmits the final spot (in a case where the tour is resumed the next day, the final spot is the first spot of the next day) and the desired conditions of the hotel to the hotel reservation system 20. The hotel reservation system 20 extracts one or more hotels on the basis of the position of the final spot and the desired conditions of the hotel.

The tour information distribution server SV1 transmits the desired conditions of the restaurant to the restaurant reservation system 30. The restaurant reservation system 30 extracts one or more restaurants on the basis of a position where the user U is predicted to stay in a meal time zone in which the user U is assumed to have a meal and desired conditions of the restaurant.

The tour information distribution server SV1 combines the extracted one or more hotels and one or more restaurants to create one or more candidate tours. The tour information distribution server SV1 presents the created one or more candidate tours to the user U. The tour information distribution server SV1 determines the candidate tour selected by the user U as the custom tour CT. The hotel reservation system 20 reserves the hotel (hotel incorporated into the custom tour CT) selected by the user U from the extracted one or more hotels. The hotel reservation system 20 notifies the hotel of the hotel arrival time as necessary. The restaurant reservation system 30 reserves the restaurant (restaurant incorporated into the custom tour CT) selected by the user U from the extracted one or more restaurants in the meal time zone.

### 3. Experience Image of Custom Tour]

FIG. 5 is a conceptual diagram of the custom tour CT.

The user U acts in accordance with the tour support information TSI presented from the tour support system 14. The tour support information TSI includes the navigation information NV provided by the navigation system 13. The tour support information TSI includes the spot introduction information SI provided by the tour information distribution server SV1, information related to a schedule for each spot, and a warning notification WN. The tour support information TSI is presented to the user U via a wearable device worn by the user U as an audio content, for example.

For example, the user U travels between the spots SP in accordance with the navigation information NV. When the user U arrives at the spot SP, the tour support system 14 notifies the user U of the scheduled time of stay at the spot SP, and guides the user U through the spot SP on the basis of the spot introduction information SI.

The tour support system 14 determines whether or not to travel on the basis of the schedule of the custom tour CT. When it is time to travel to the next spot SP, the tour support system 14 issues the warning notification WN related to a travel schedule between the spots SP to the user U. The tour information distribution server SV1 checks the next spot SP at the timing when the user U leaves the spot SP, and notifies the user U of the destination (destination place). The navigation system 13 guides the user U to the destination on the basis of the navigation information NV.

### 4. Description of Spot]

FIG. 6 is an explanatory diagram of the spot SP.

In the master schedule MS, an assist area GA and a travel start determination area JA are defined for each spot SP. The assist area GA is an area where the spot introduction information SI is provided to the user U in order to assist the user U. The travel start determination area JA is an area where the start of travel from the spot SP where the user is currently staying is determined. The arrival of the user U is determined on the basis of the assist area GA.

The tour support system 14 determines that the user U has arrived at the spot SP due to the user U traveling from the outside to the inside of the assist area GA, and generates spot specification information for specifying the spot SP. The travel to the assist area GA is determined on the basis of the position information of the user U detected by the user terminal TM. The position information of the user U may be detected on the basis of the GPS data, or may be detected on the basis of some signal received from an entrance gate of the assist area GA when the user passes through the gate. The tour information distribution server SV1 starts providing the spot introduction information SI due to the acquisition of the spot specification information from the tour support system 14.

The tour support system 14 asks the user U whether the user U travels from the spot SP where the user U is currently staying due to the user U traveling from the assist area GA to the travel start determination area JA. The tour support system 14 receives a notification that the user U starts traveling from the user U, and generates travel start information due to the user U traveling to the outside of the travel start determination area JA. The travel start information is information indicating that the user U has started traveling from the current spot SP. The navigation system 13 starts navigation due to the acquisition of the travel start information. When the user U is in the travel start determination area JA, the navigation system 13 does not perform navigation.

In the example of FIG. 6, the assist area GA and the travel start determination area JA are indicated by circles, but the assist area GA and the travel start determination area JA do not need to be indicated by circles. The shape of the assist area GA and the travel start determination area JA can be freely set in accordance with the shape of a facility to be visited or the like. The shape of the assist area GA and the travel start determination area JA can be manually set by the creator CR, or can be automatically set when the creator CR designates a place.

### 4. Support of User’s Action

### 1. Route Guide]

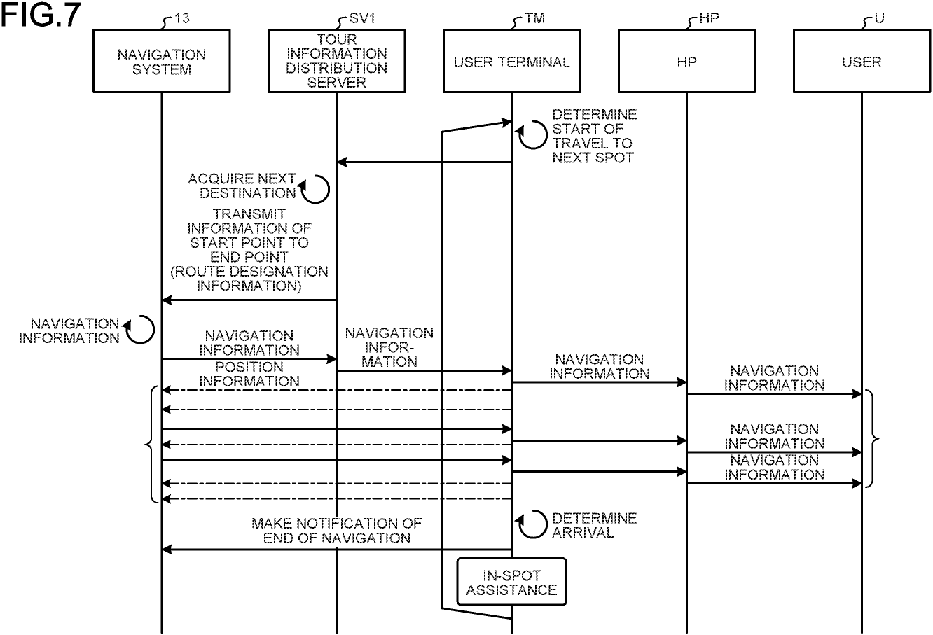

FIG. 7 is an explanatory diagram of a route guide.

First, the tour support system 14 (user terminal TM) determines the start of travel of the user U on the basis of the position information of the user U. When travel from the current spot SP is determined, the tour information distribution server SV1 extracts the destination of the next spot SP from the schedule of the custom tour CT. The tour information distribution server SV1 transmits route designation information including a start point (current place) and an end point (destination) to the navigation system 13. The navigation system 13 generates the navigation information NV to the destination due to the acquisition of the travel start information of the user U, and presents the navigation information NV to the user U via the tour support system 14. When the user U arrives at the destination, the tour support system 14 assists the user U using the spot introduction information SI provided by the tour information distribution server SV1 (in-spot assistance).

### 2. First Mode of In-Spot Assistance]

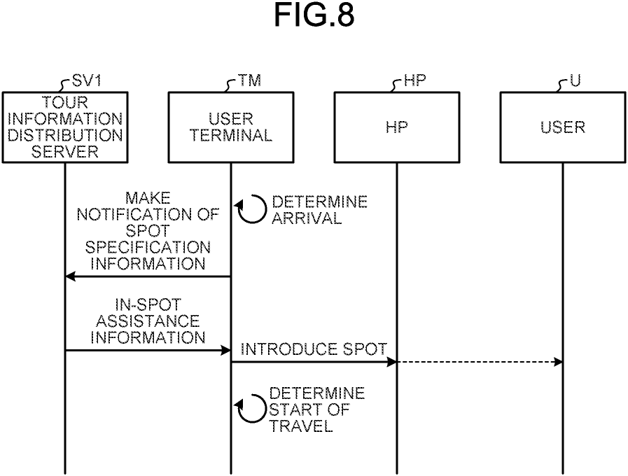

FIG. 8 is an explanatory diagram of a first mode of in-spot assistance.

First, the tour support system 14 (user terminal TM) determines arrival at the next spot SP on the basis of the position information of the user U. When the user U arrives at the spot SP, the tour support system 14 generates spot specification information for specifying the arrived spot SP on the basis of the position information of the user U. The tour information distribution server SV1 extracts in-spot assistance information corresponding to the arrived spot SP from the schedule of the custom tour CT. The in-spot assistance information includes the scheduled time of stay at the spot SP and the spot introduction information SI. The tour information distribution server SV1 notifies the user U of the scheduled time of stay at the spot SP as the tour support information TSI via the tour support system 14 due to the acquisition of the spot specification information from the tour support system 14. Then, the tour information distribution server SV1 presents the spot introduction information SI of the current spot SP specified by the spot specification information to the user U as the tour support information TSI via the tour support system 14. The tour support system 14 determines the start of travel to the next spot SP due to the user U traveling to the travel determination area JA.

### 3. Second Mode of In-Spot Assistance]

FIGS. 9 to 12 are explanatory diagrams of a second mode of the in-spot assistance.

In the present mode, a plurality of in-spot spots SSP are incorporated into the spot SP. For each in-spot spot SSP, the tour information distribution server SV1 extracts the spot introduction information SI corresponding to the in-spot spot SSP from the custom tour CT and presents the spot introduction information SI to the user U via the tour support system 14.

FIG. 9 illustrates an example in which the sub-schedule SU is incorporated into the spot SP. The master schedule MS in FIG. 9 includes a main schedule MA and one or more sub-schedules SU. The main schedule MA includes information related to a plurality of spots SP, a standard time of stay at each spot SP, and a standard route between the spots SP. The sub-schedule SU includes information related to a plurality of in-spot spots SSP set in the spot SP, and a standard time of stay at each in-spot spot SSP.

The master schedule MS in FIG. 9 has a main schedule MA including a first spot SP1, a second spot SP2, a third spot SP3, and a fourth spot SP4. A sub-schedule SU including four in-spot spots SSP21 to SSP24 is incorporated into the second spot SP2. A sub-schedule SU including two in-spot spots SSP31 to SSP32 is incorporated into the third spot SP3.

The sub-schedule SU is created using the raw data RD uploaded to the tour information distribution server SV1. In the raw data RD, the spot introduction information SI created by a specialized creator CR is incorporated into each in-spot spot SSP. For example, in the second spot SP2, information of an exhibit guide generated by an art specialist is incorporated into each exhibit set as the in-spot spot SSP. Lunch information and sweets information generated by a gourmet reporter is incorporated into the third spot SP3. By incorporating the high-quality raw data RD generated by the specialized creator CR, the tour becomes attractive.

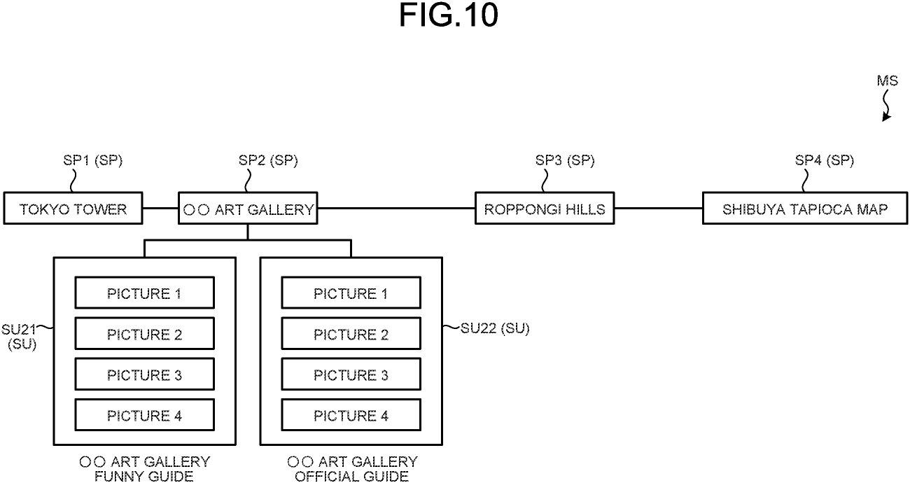

FIG. 10 illustrates an example in which a selectable sub-schedule SU is incorporated in the spot SP. The master schedule MS includes one or more spots SP in which a plurality of selectable sub-schedules SU are registered. The tour information distribution server SV1 creates the custom tour CT by incorporating the sub-schedule SU input as the optional information from the user U into each of the one or more spots.

In the master schedule MS of FIG. 10, two selectable sub-schedules SU21 to SU22 are incorporated into the second spot SP2. The two sub-schedules SU target the same exhibit, but exhibit guide information (spot introduction information SI) is different. The user U can select a favorite sub-schedule SU when creating the custom tour CT.

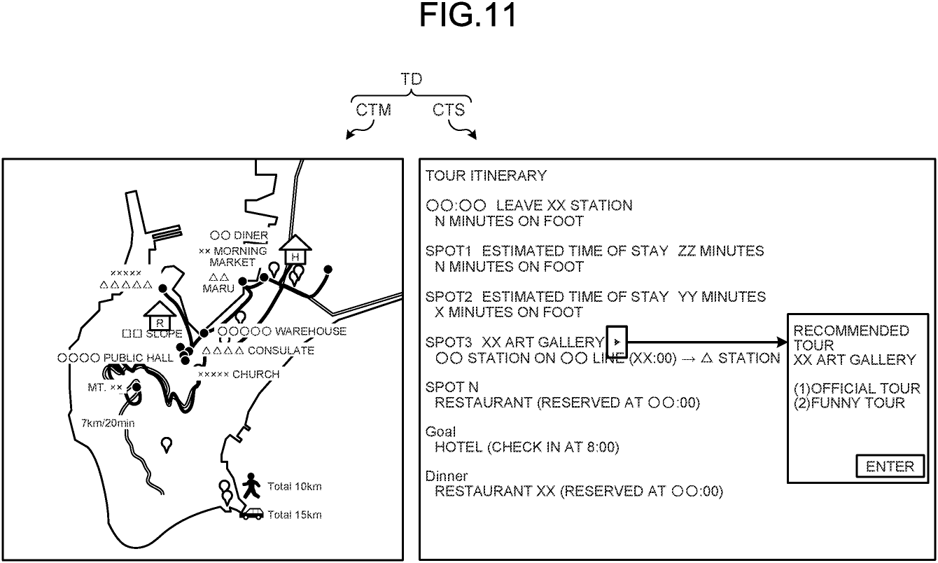

The sub-schedule SU can be selected on the tour information screen TD. In the example of FIG. 11, an arrow key is displayed on the right side of “SPOT 3”. When the arrow key is clicked, a plurality of selectable sub-schedules SU are displayed. The user U can input a favorite sub-schedule SU as optional information via the tour information screen TD. When the sub-schedule SU is selected by the user U, the time of stay at each spot SP, the route between the spots SP, the reservation time of the restaurant, and the check-in time of the hotel are calculated and displayed on the tour information screen TD.

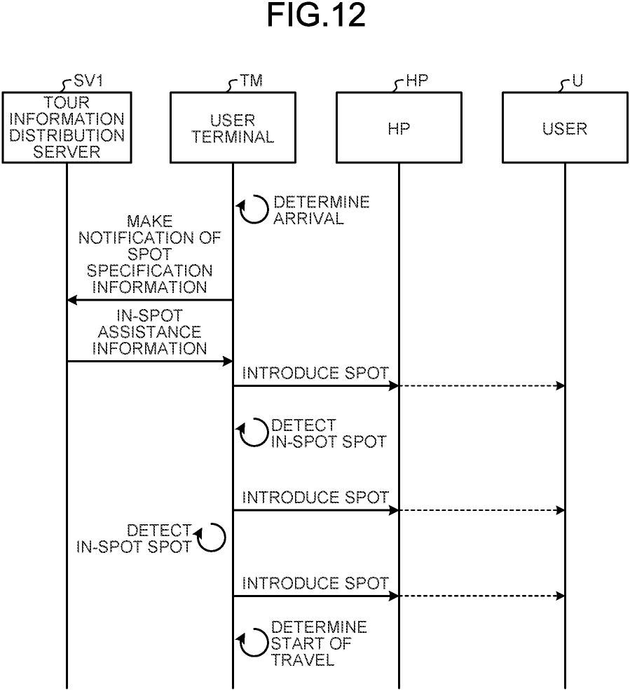

FIG. 12 is an explanatory diagram of the in-spot assistance. When the user U arrives at the spot SP, the tour support system 14 generates spot specification information. The tour information distribution server SV1 extracts the in-spot assistance information from the schedule of the custom tour CT on the basis of the spot specification information. The in-spot assistance information includes the position, scheduled time of stay, and spot introduction information SI of each in-spot spot SSP. The user U sequentially visits the plurality of in-spot spots SSP. Every time the user U arrives at the in-spot spot SSP, the tour information distribution server SV1 extracts the scheduled time of stay at the arrived in-spot spot SSP from the custom tour CT. The tour support system 14 notifies the user U of the scheduled time of stay as the tour support information TSI, and presents the spot introduction information SI of the arrived in-spot spot SSP to the user U. The tour support system 14 determines the start of travel to the next spot SP due to the user U traveling to the travel determination area JA.

### 4. Time Keeping]

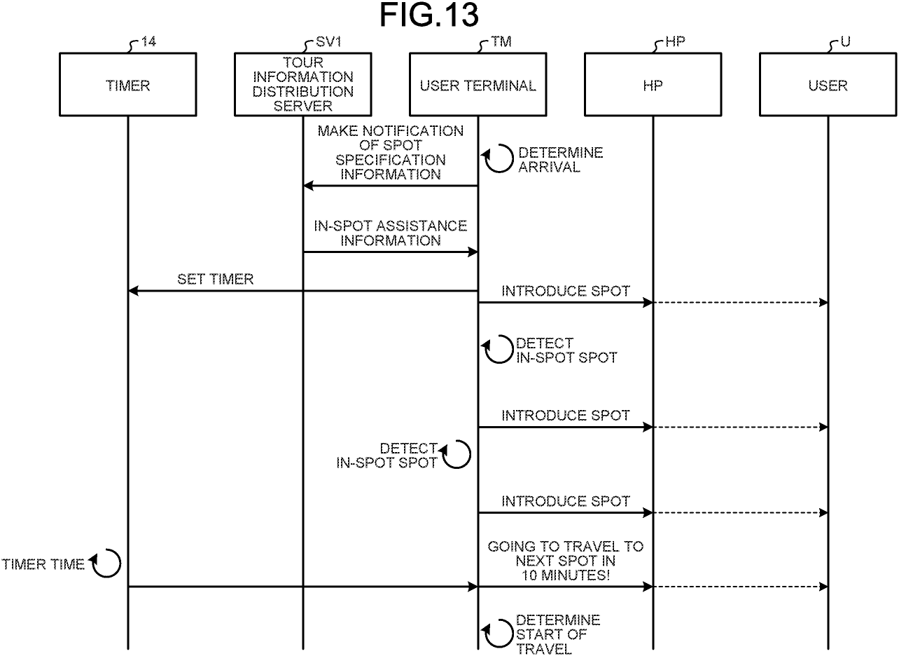

FIG. 13 is an explanatory diagram of time keeping.

When the user U arrives at the spot SP, the tour support system 14 sets a timer. The tour support system 14 monitors the progress of the schedule in the spot SP on the basis of sensor information (GPS data and the like) detected by the user terminal TM and timer information. The tour support system 14 presents information based on the progress to the user U.

For example, the tour support system 14 calculates the remaining time on the basis of the time measured by the timer and the scheduled time of stay at the spot SP. In a case where there is not much time in the remaining schedule, the tour support system 14 prompts the user U to advance the schedule. At that time, the tour support system 14 can notify the user U of the progress of the schedule and the remaining time together. In a case where the remaining time approaches the minimum time required to carry out the remaining schedule, the tour support system 14 makes a notification to prompt the user U to travel to the next spot SP. The minimum time is, for example, a time simply required to travel to the travel start determination area JA of the spot SP with the time of stay at the remaining in-spot spots SSP being zero.

In a case where there is a time pressure in the travel start schedule to the next spot SP, the tour support system 14 warns the user U about the travel schedule between the spots SP. For example, in a case where the means of transportation to the next spot SP is public transportation such as a train, a bus, an airplane, or a ship, the tour support system 14 prompts the user U to travel to the next spot SP on the basis of a transfer time. In a case where the remaining time approaches the minimum time required to carry out the remaining schedule, the tour support system 14 notifies the user of the next transfer time. At that time, the tour support system 14 can notify the user U of information of the transportation cost together.

### 5. Route Change]

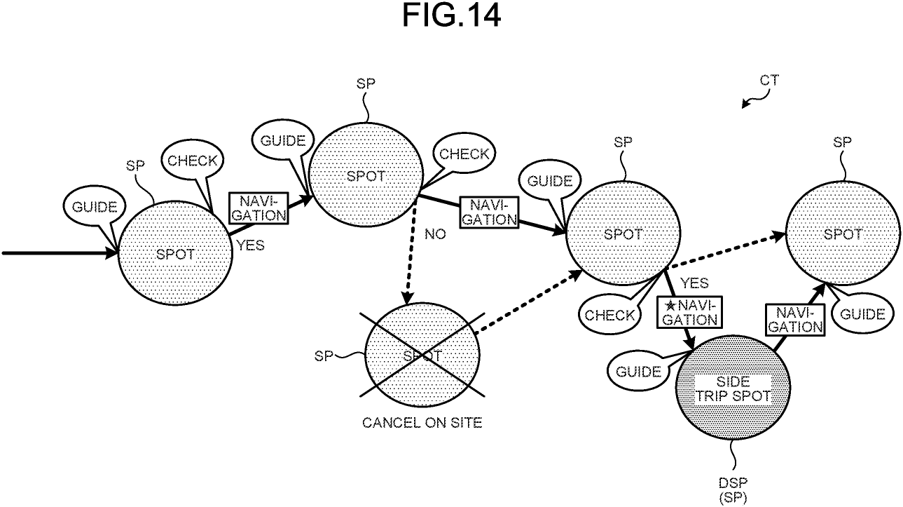

FIG. 14 is a conceptual diagram of a route change.

The user U can change the set route during the execution of the custom tour CT. For example, the user U can cancel the spot SP scheduled as the next spot SP and visit the spot SP one ahead of the spot SP. In addition, the user U can visit places and events that are not included in the schedule of the custom tour CT as side trip spots DSP. In a case where a side trip is selected by the user U, the tour information distribution server SV1 incorporates the side trip spot DSP input from the user U into the custom tour CT during the execution of the custom tour CT.

The side trip spot DSP can be registered in the master schedule MS as an extended option by the creator CR who has created the master schedule MS in order to provide a deeper experience. In a case where the side trip spot DSP is not registered in the master schedule MS, the tour information distribution server SV1 can extract a spot SP suitable for the concept of the custom tour CT as the side trip spot DSP from the plurality of spots SP registered in the tour information distribution server SV1. For example, the tour support system 14 proposes one or more side trip spots DSP near the user U to the user U as the presentation of the tour support information TSI. The user U can select a favorite side trip spot DSP by gesture, voice, or the like. The tour information distribution server SV1 incorporates the side trip spot DSP selected by the user U from one or more proposed side trip spots DSP into the custom tour CT.

The route change may be detected on the basis of change information input from the user U, or may be automatically detected on the basis of action sensing performed by the user terminal TM. In a case where the route is changed, the schedule after the change is calculated, and a notification of the schedule after the change is provided to the user U through the tour information screen TD.

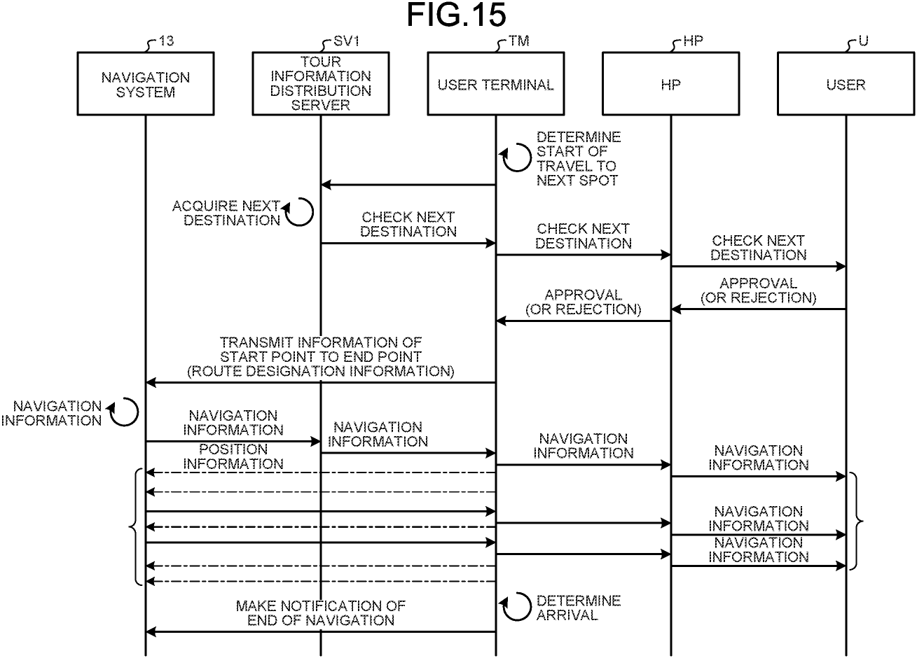

FIG. 15 is an explanatory diagram of a route guide.

First, the tour support system 14 (user terminal TM) determines the start of travel of the user U on the basis of the position information of the user U. When travel from the current spot SP is determined, the tour information distribution server SV1 extracts the destination of the next spot SP from the schedule of the custom tour CT. The tour information distribution server SV1 asks the user U as to the next destination. In a case where the extracted destination is approved, the tour information distribution server SV1 transmits route designation information with the approved destination being an end point to the navigation system 13. In a case where the extracted destination is rejected and another destination is input by the user U, the tour information distribution server SV1 transmits route designation information with the input destination being an end point to the navigation system 13. The navigation system 13 generates the navigation information NV to the destination due to the acquisition of the travel start information of the user U, and presents the navigation information NV to the user U via the tour support system 14.

### 6. Time-Limited Event]

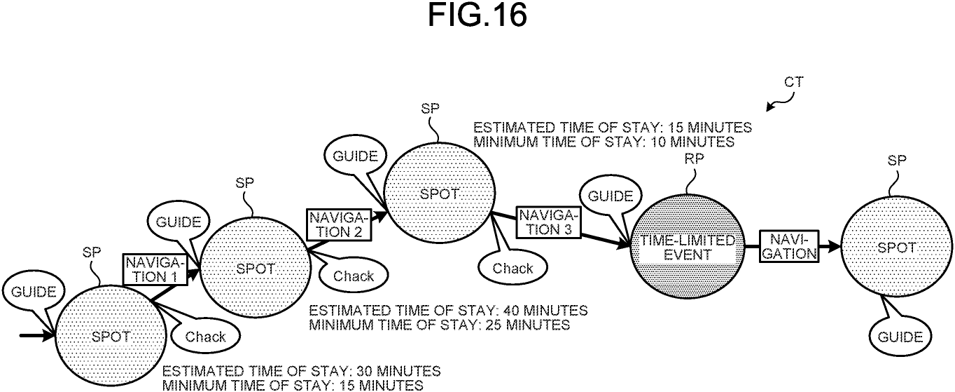

FIG. 16 is a conceptual diagram of the custom tour CT including a time-limited event RP.

The custom tour CT includes a time-limited event RP. The event RP includes a movie, a theater, a concert, and a restaurant with a designated time, a festival and a firework with a fixed time, a sunrise and a sunset (setting sun), and the like. The tour information distribution server SV1 extracts the time-limited event RP from the schedule of the custom tour CT. The tour information distribution server SV1 determines whether to visit the event RP on the basis of the current time and the remaining schedule. The tour information distribution server SV1 adjusts the remaining schedule on the basis of the determination result.

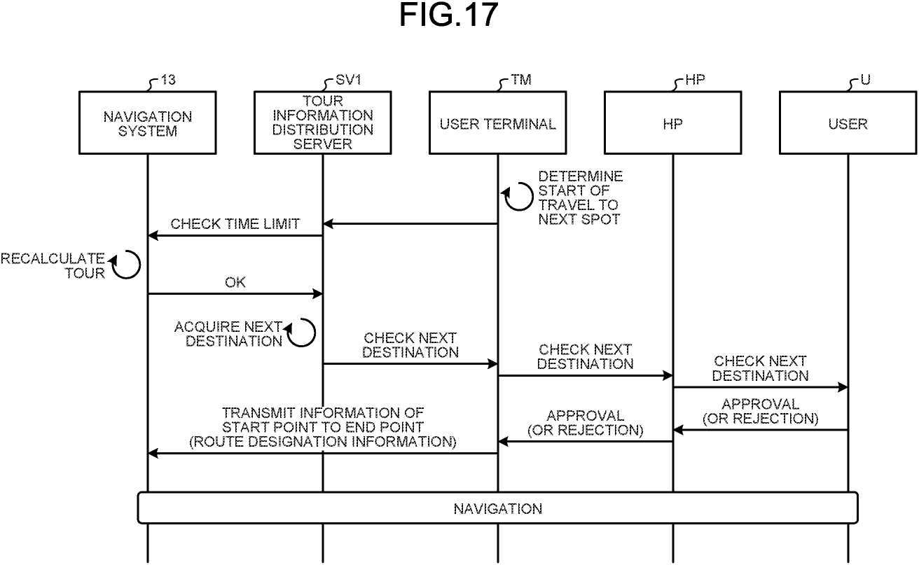

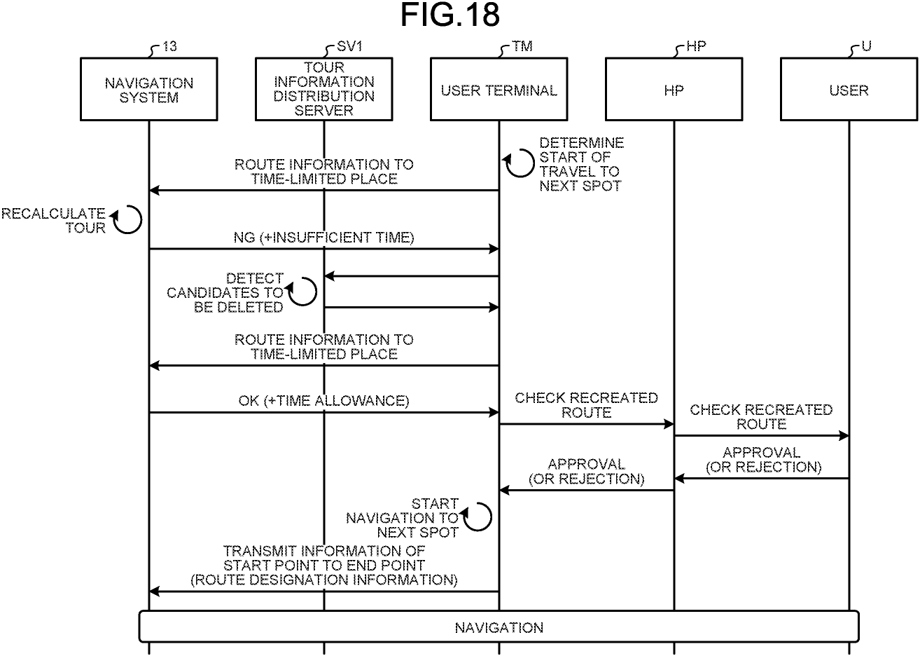

FIGS. 17 and 18 are explanatory diagrams of a route guide in consideration of the time-limited event RP.

When travel from the current spot SP is determined on the basis of a travel start determination, the tour information distribution server SV1 determines whether to visit to the event RP on the basis of the total travel time of the remaining route and the minimum time of stay at each remaining spot SP.

As illustrated in FIG. 17, in a case where the event RP can be visited, the tour information distribution server SV1 extracts the next destination on the basis of the current schedule and requests the user U for check via the tour support system 14. In a case where the approval is obtained from the user U, the tour information distribution server SV1 transmits route designation information with the approved destination being an end point to the navigation system 13. In a case where another destination is input by the user U, the tour information distribution server SV1 transmits route designation information with the input destination being an end point to the navigation system 13.

As illustrated in FIG. 18, in a case where the event RP cannot be visited, the tour support system 14 notifies the user U of the fact that the user U cannot visit the event RP and the insufficient time as the presentation of the tour support information TSI. As the presentation of the tour support information TSI, the tour support system 14 proposes deletion of one or more spots SP to the place where the event RP is held from the remaining plural spots SP to the user U in accordance with the progress of the custom tour CT. The proposal for deletion is made, for example, on the basis of the priority of each spot SP to be described later.

The tour information distribution server SV1 creates the remaining schedule on the basis of the information of the deleted spot. The tour information distribution server SV1 presents the created schedule and the time allowance caused by the deletion of the spot SP to the user U via the tour support system 14, and requests the user U for check. When the approval is obtained from the user, this schedule is set as a subsequent schedule. When the approval is not obtained, the remaining schedule is created while changing candidates for a spot to be deleted until the approval is obtained. The tour information distribution server SV1 extracts the next destination from the approved schedule and transmits route designation information with the extracted destination being an end point to the navigation system 13.

In a case where an approvable schedule cannot be obtained, the tour support system 14 checks whether or not the time when the event RP is held can be changed in accordance with the progress of the custom tour CT as the presentation of the tour support information TSI. In a case where the time can be changed, the tour support system 14 proposes the change of the time to the user U as the presentation of the tour support information TSI. The user U can select whether to accept the proposal by gesture, voice, or the like. In a case where the time cannot be changed, the tour support system 14 proposes the cancellation of the event RP to the user U as the presentation of the tour support information TSI. The case where an approvable schedule cannot be obtained refers to a case where the event RP cannot be visited even if all the spots SP up to the place where the event RP is held are deleted, and a case where all the schedules presented by changing the candidates for a spot to be deleted are rejected by the user U.

### 7. Route Change Based on Priority Information]

The creator CR can give priority to a plurality of spots SP registered in the master schedule MS. For example, the master schedule MS includes priority information related to the priority of each spot SP. As the presentation of the tour support information TSI, the tour support system 14 makes a proposal to delete one or more spots SP from the plurality of remaining spots SP on the basis of the priority information in accordance with the progress of the custom tour CT. The user U can select a spot SP to be deleted by gesture, voice, or the like.

### 8. Change in Arrival Time at Reserved Hotel and Cancellation]

As the presentation of the tour support information TSI, the tour support system 14 makes a proposal to change the arrival time at the reserved hotel or to cancel the reserved hotel to the user U in accordance with the progress of the custom tour CT. In the case of proposing cancellation, the tour support system 14 notifies the user U of a cancellation fee. The user U can select whether to accept the proposal by gesture, voice, or the like. In a case where the approval of the user U is obtained, the tour information distribution server SV1 changes the arrival time at the reserved hotel or cancels the reserved hotel through the hotel reservation system 20. The tour support system 14 can also make a notification about the change in the arrival time at the reserved hotel or cancel the reserved hotel via the tour information distribution server SV1 in accordance with the progress of the custom tour CT being executed without making the above proposal.

### 9. Change in Arrival Time at Reserved Restaurant and Cancellation]

As the presentation of the tour support information TSI, the tour support system 14 makes a proposal to change the arrival time at the reserved restaurant or to cancel the reserved restaurant to the user U in accordance with the progress of the custom tour CT. In the case of proposing cancellation, the tour support system 14 notifies the user U of a cancellation fee. The user U can select whether to accept the proposal by gesture, voice, or the like. In a case where the approval of the user U is obtained, the tour information distribution server SV1 changes the arrival time at the reserved restaurant or cancels the reserved restaurant through the restaurant reservation system 30. The tour support system 14 can also make a notification about the change in the arrival time at the reserved restaurant or cancel the reserved restaurant via the tour information distribution server SV1 in accordance with the progress of the custom tour CT without making the above proposal.

### 5. Creation of Master Schedule

### 1. Extraction of Actual Schedule]

FIG. 19 is a diagram illustrating an example of the master schedule creation screen SC.

The master schedule MS can be created by using an action record of a tour executed by a traveler in the past. The traveler as the creator CR can create a new travel content TC based on real experience.

The master schedule MS is created using the action record acquisition system 15, the schedule extraction system 16, the master schedule creation system 17, and the event database 18. The traveler extracts an actual schedule (schedule actually carried out in the tour) from the action record of the tour, and edits the actual schedule to create a new master schedule MS. The actual schedule can be checked on the master schedule creation screen SC. The actual schedule is reproduced on the master schedule creation screen SC using the avatar of the traveler, street view, or the like.

The traveler inputs tour data to the action record acquisition system 15. The tour data includes the travel history of the traveler on the tour, and captured data such as photographs and videos. The captured data includes data captured by the traveler and data captured by a companion of the traveler. The travel history and the captured data are associated with GPS data. The action record acquisition system 15 extracts an action record during the tour from the tour data. The action record includes position information of the traveler and capturing information of the captured data. The position information is information indicating the position of the traveler at each time. The capturing information is information indicating a captured position, a captured time, and a captured content.

The schedule extraction system 16 extracts an actual schedule on the basis of the action record associated with the GPS data. The actual schedule includes a plurality of visit spots VSP visited during the tour, the time of stay at each visit spot VSP, and the route between the visit spots VSP.

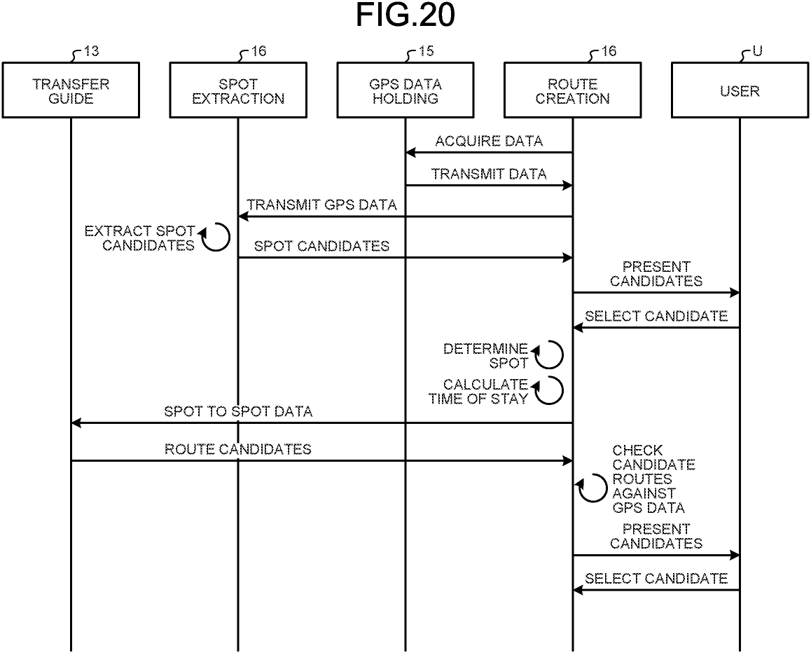

FIG. 20 is an explanatory diagram of actual schedule extraction processing.

The schedule extraction system 16 acquires an action record associated with GPS data from the action record acquisition system 15. The action record includes position information of a traveler and capturing information of captured data. The schedule extraction system 16 extracts information such as a traffic line, a travel time, a travel speed, and a time of stay of the traveler on the basis of the position information of the traveler. The schedule extraction system 16 extracts information such as a captured content and a frequency of capturing (number of times of capturing in a unit area) on the basis of the capturing information.

The schedule extraction system 16 calculates the importance of each place on the basis of the time of stay, the captured content, and the frequency of capturing. For example, a place with a long time of stay and a place with high frequency of capturing are likely to be recognized as important spots by the traveler. Therefore, high importance is given. Sightseeing spots include tourist spots such as famous and historic sites. In a case where such a tourist spot is included in the subject, there is a high possibility that the place where the subject is present is recognized as an important spot by the traveler. Therefore, high importance is given.

The schedule extraction system 16 extracts a place with high importance as a spot candidate. The schedule extraction system 16 requests the traveler to check a spot candidate, and determines the spot candidate approved by the traveler as a visit spot VSP. When a plurality of visit spots VSP are specified on the traffic line of the traveler, the schedule extraction system 16 calculates the time of stay at each of the visit spots VSP. Note that the schedule extraction system 16 can use, as spot candidates, a spot registered in the master schedule MS that provides a similar tour route and a spot registered as the raw data RD. By using a spot whose position and range are defined, the action of the traveler is accurately estimated.

The schedule extraction system 16 extracts a route candidate between the visit spots VSP via the navigation system 13. The schedule extraction system 16 requests the traveler to check a route candidate, and determines the route candidate approved by the traveler as a route between the visit spots VSP. In a case where there is a plurality of route candidates, the schedule extraction system 16 estimates the traveler’s means of transportation (train, bus, ship, airplane, taxi, bicycle, walking, and the like) on the basis of sensor information (information such as acceleration and angular velocity detected by a motion sensor, usage information of an IC riding card, and the like) detected at the time of travel between the visit spots VSP. The schedule extraction system 16 presents a route candidate based on the estimated means of transportation to the traveler and requests the traveler for check. In a case where the means of transportation cannot be estimated, the schedule extraction system 16 presents a plurality of route candidates to the traveler and request the traveler for check. Note that the schedule extraction system 16 can also use, as a route candidate, a method of travel between spots registered in the master schedule MS that provides a similar tour route.

The visit spot VSP can include an event such as a festival or a firework. The schedule extraction system 16 extracts, from the event database 18, events held on the route of the tour on the day when the tour was executed. The schedule extraction system 16 determines whether to extract an event as the visit spot VSP on the basis of the time of stay at the event venue estimated from the actual schedule.

### 2. Actual Schedule Processing]

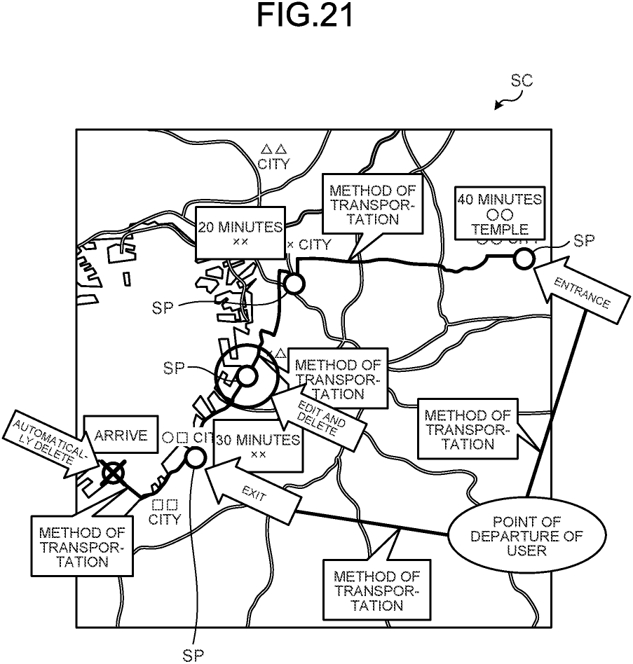

FIG. 21 is an explanatory diagram of actual schedule processing.

The master schedule creation system 17 acquires the actual schedule as a tentative schedule. The traveler edits the tentative schedule on the master schedule creation screen SC and creates the master schedule MS. Since the start point and the end point of the tour are not visit spots, these points are automatically deleted from the tentative schedule by the master schedule creation system 17.

The traveler can select an unnecessary spot SP from a plurality of spots SP included in the tentative schedule. The master schedule creation system 17 deletes the unnecessary spot SP selected by the traveler from the tentative schedule. The traveler can newly add a spot SP not included in the tentative schedule. The master schedule creation system 17 adds the spot SP added by the traveler to the tentative schedule. The master schedule creation system 17 extracts a route between the added spot SP and the previous spot SP and a tentative route between the added spot SP and the next spot SP via the navigation system 13, and registers the routes in the tentative schedule.

The traveler can change the means of transportation between the spots SP. The master schedule creation system 17 changes the means of transportation between the spots SP to the means of transportation designated by the traveler. In a case where the means of transportation is a car, the master schedule creation system 17 sets a destination place of each spot SP as a parking lot. During the execution of the custom tour CT, the tour information distribution server SV1 dynamically changes the route on the basis of the availability information of the parking lot.

### 3. Assignment of Picture to Spot]

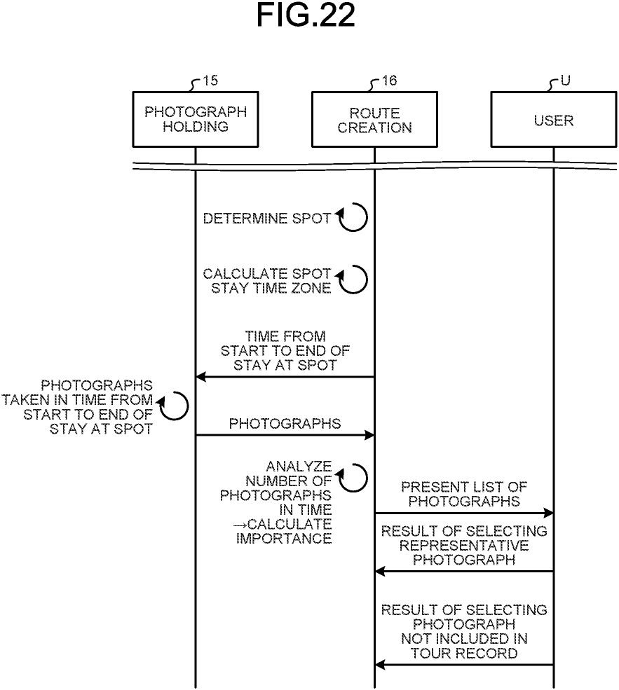

FIG. 22 is an explanatory diagram of processing of assigning the spot introduction image SIM (see FIG. 23).

In the master schedule MS, the spot introduction image SIM is registered in each spot SP. When the position of each spot SP and the time of stay at each spot SP are extracted, the schedule extraction system 16 extracts one or more photographs captured during the stay of the spot as candidate images from the action record.

The schedule extraction system 16 calculates the importance of each candidate image on the basis of the captured content. For example, high importance is given to a candidate image with high relevance to the spot SP (for example, a photograph in which a famous site or a historic site related to the spot SP is included in the subject). Low importance is given to a candidate image (for example, a photograph in which only a friend or food is included as a main subject, or the like.) with low relevance to the spot SP.

The schedule extraction system 16 presents each candidate image together with its importance to the traveler. The schedule extraction system 16 determines the candidate image selected by the traveler from the extracted one or more candidate images as the spot introduction image SIM.

Photographs and videos are usually taken at visit spots, but photographing is prohibited at capturing prohibited spots such as art galleries. In this case, the schedule extraction system 16 extracts one or more images related to the spot SP from the network as candidate images. The schedule extraction system 16 determines the candidate image selected by the traveler from the extracted one or more candidate images as the spot introduction image SIM.

FIG. 23 illustrates an image of the master schedule creation UI.

The map MSM and the tour schedule MSS are displayed on the master schedule creation screen SC. The position and name of each spot SP are displayed on the map MSM. In the map MSM, a standard route is displayed by a line connecting the spots SP. In the tour schedule MSS, the name of the spot SP, the spot introduction image SIM, the recorded sentence of the spot SP, the audio guide AG, the standard route between the spots SP, the standard time of stay at each spot SP, and the like are displayed. The recorded sentence is a sentence indicating the introduction of the spot SP. The audio guide AG is an icon for outputting the recorded sentence as a voice. During the execution of the custom tour CT, a notification of the content of the recorded sentence is provided to the user as the spot introduction information SI.

### 4. Incorporation of Event]

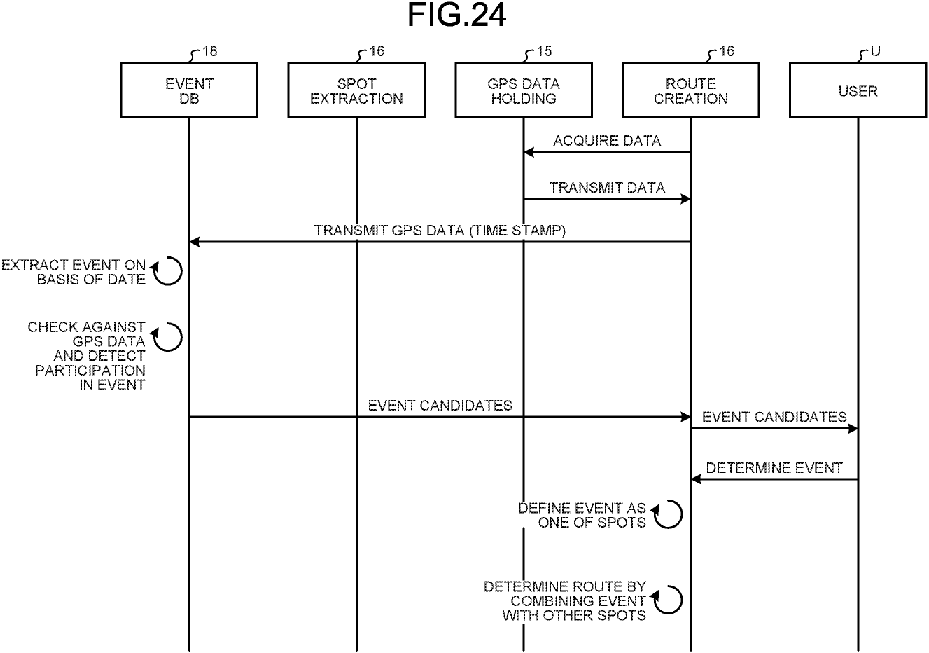

FIG. 24 is an explanatory diagram of event extraction processing.

In Japan, various events are held throughout the year. The schedule extraction system 16 can also extract an event such as a firework or a festival as the visit spot VSP. The schedule extraction system 16 extracts, from the event database 18, one or more events held on the route of the tour on the day when the tour was executed. The schedule extraction system 16 extracts one or more event candidates from the extracted one or more events on the basis of the time of stay at the event venue estimated from the actual schedule. The schedule extraction system 16 presents each event candidate to the traveler. The schedule extraction system 16 determines, as the visit spot VSP, an event candidate selected by the traveler from the extracted one or more event candidates.

### 5. Incorporation of Label Information]

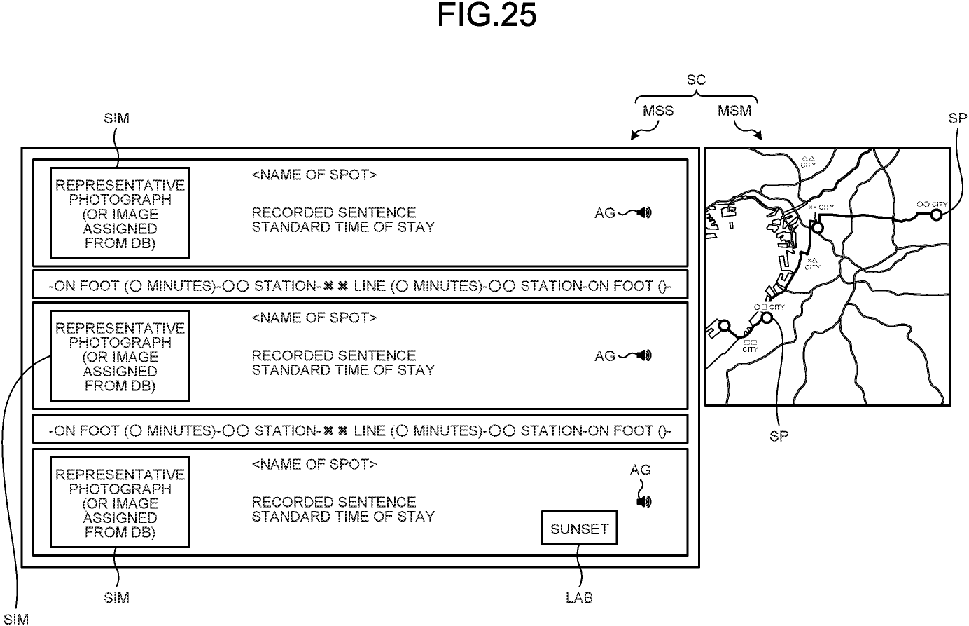

FIG. 25 is an explanatory diagram of the master schedule MS including label information.

In special events such as sunset viewing, sunrise viewing, and night scene viewing, the time to visit the event varies depending on the date of the tour. The visit time of the special event is registered not by the actual time but by label information LAB such as “sunset”, “sunrise”, and “night scene”. The label information is information indicating the purpose of the event. The label information indirectly represents the visit time of the event in accordance with the purpose of the event. In a case where the label information LAB is registered in the master schedule MS, the tour information distribution server SV1 calculates the visit time of the special event based on the label information LAB on the basis of the date of the custom tour CT. The tour information distribution server SV1 adjusts the schedule of the entire custom tour in accordance with the visit time of the special event.

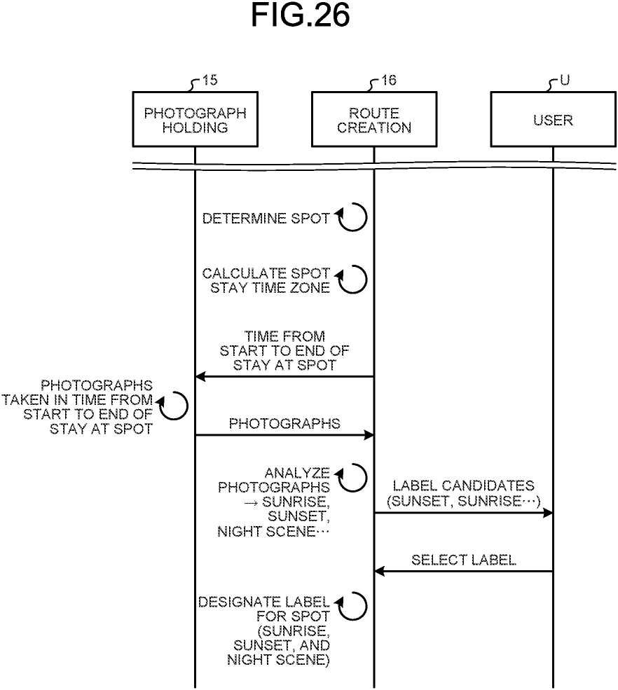

FIG. 26 is an explanatory diagram of special event extraction processing.

The schedule extraction system 16 extracts one or more label candidates on the basis of captured data captured during the stay of the spot. The schedule extraction system 16 presents each label candidate to the traveler. The schedule extraction system 16 determines, as label information, the label candidate selected by the traveler from the extracted one or more label candidates, and registers the label candidate in the visit spot VSP.

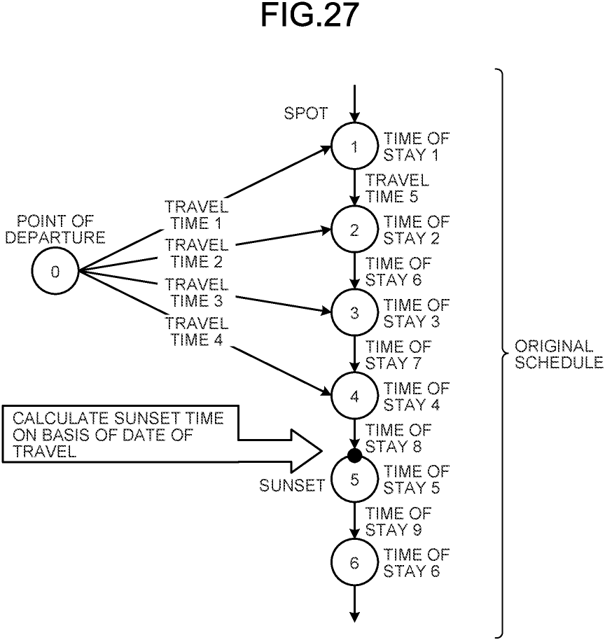

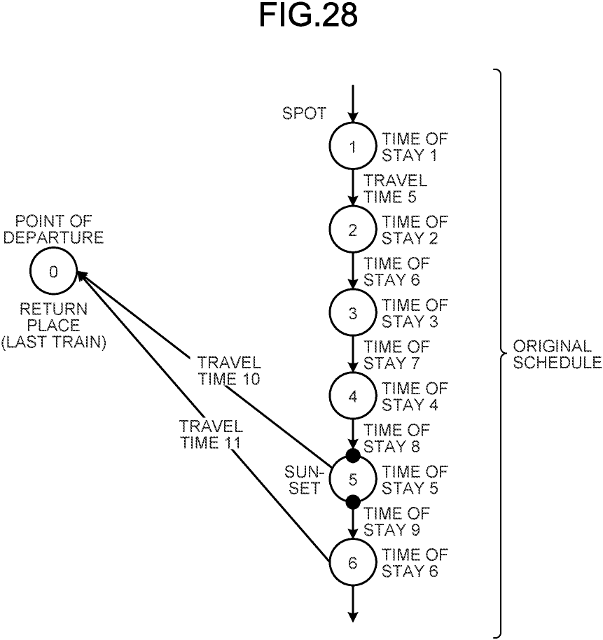

FIGS. 27 and 28 are explanatory diagrams of schedule adjustment based on a special event.

FIG. 27 illustrates a schedule of departing from a point of departure “0” and staying at a spot “6”. The special event is sunset viewing. The master schedule MS includes spots “1” to “6” as an original schedule. The special event is held at a spot “5”.

The tour information distribution server SV1 calculates the visit time of the spot “5” on the basis of the date of the custom tour CT. The tour information distribution server SV1 creates one or more candidate tours in time for the visit time of the spot “5”. In the example of FIG. 27, the following four schedules SCL (the time of stay at each spot SP and the route between the spots SP) are calculated. The tour information distribution server SV1 extracts one or more schedules in time for the visit time of the spot “5” in each schedule, and creates one or more candidate tours including the extracted one or more schedules.

SCL1: “0” → “4” → “5”
SCL2: “0” → “3” → “4” → “5”
SCL3: “0” → “2” → “3” → “4” → “5”
SCL4: “0” → “1” → “2” → “3” → “4” --> “5”

The tour information distribution server SV1 presents the created one or more candidate tours to the user U. The tour information distribution server SV1 determines the candidate tour selected by the user U as the custom tour CT. In a case where all the candidate tours are rejected by the user U, the tour information distribution server SV1 proposes a schedule obtained by dividing the custom tour CT of FIG. 27 into a plurality of days. The user U can select whether to accept the proposal by gesture, voice, or the like.

FIG. 28 illustrates a schedule of departing from the point of departure “0”, visiting each spot SP, and then returning to the point of departure “0”. The schedule is the same as the schedule in FIG. 27 except that the point of departure “0” is a return place. Also in this example, the tour information distribution server SV1 creates one or more candidate tours in time for the visit time of the spot “5” and presents the created one or more candidate tours to the user U. In the example of FIG. 28, for example, a candidate tour including a schedule of “0” → “5” and a candidate tour including a schedule of “0” → “5” → “6” are created. The tour information distribution server SV1 determines the candidate tour selected by the user U as the custom tour CT.

In the schedule of FIG. 28, no hotel is set, and the point of departure “0” is the return place. As described above, in a case where no hotel is designated and in a case where the user U desires to return home, the tour information distribution server SV1 does not propose a schedule obtained by dividing the custom tour CT into a plurality of days.

### 6. Effects

The information processing system 1 includes the custom tour creation system 12 and the tour support system 14. The custom tour creation system 12 creates the custom tour CT by incorporating the optional information input from the user U into the master schedule MS including a plurality of spots SP, the standard time of stay at each spot SP, and the standard route between the spots SP. The tour support system 14 monitors the progress of the custom tour CT being executed. The tour support system 14 presents the tour support information TSI based on the progress to the user U to support the action of the user U.

With this configuration, by the user U freely adding the optional information to the master schedule MS defined as a rough frame, the custom tour CT is created. Therefore, it is possible to present the custom tour CT that does not impair the degree of freedom of individual travel while maintaining the convenience of a package tour. During the execution of the custom tour CT, the tour support information TSI based on the progress is presented to the user U. By acting in accordance with the tour support information TSI, the user U can enjoy a comfortable tour without feeling significantly stressed.

The tour support information TSI includes navigation information between the spots SP, the spot introduction information SI of each spot SP, a warning related to a travel schedule between the spots SP, and a proposal related to a change in the schedule of the custom tour CT.

With this configuration, the user U can easily take an appropriate action based on the progress.

The tour support system 14 notifies the user U of the tour support information TSI by voice. The tour support system 14 detects the response of the user U to the tour support information TSI on the basis of the voice of the user U or the gesture to the wearable device worn by the user.

With this configuration, the acquisition of the tour support information TSI and the response to the tour support information TSI are performed without the user taking out input and output devices or performing complicated input and output operations. The progress of the custom tour CT is hardly interrupted by the input and output operation. Therefore, it is easy to soak up the atmosphere of the custom tour CT.

The information processing system 1 includes the hotel reservation system 20. The hotel reservation system 20 makes a reservation for a hotel that meets the desired conditions. The desired conditions of the hotel are input as the optional information.

With this configuration, the hotel reservation is automatically made in accordance with the schedule of the custom tour CT. Therefore, the burden on the user U for reserving the hotel is reduced.

The hotel reservation system 20 extracts one or more hotels on the basis of the position of the final spot and the desired conditions of the hotel. The hotel reservation system 20 reserves the hotel selected by the user U from the extracted one or more hotels.

With this configuration, a hotel in an appropriate location based on the schedule of the custom tour CT is extracted. The user U can select a favorite hotel from the extracted one or more hotels. Therefore, a hotel in an appropriate location reflecting the preference of the user U is reserved.

The tour support system 14 makes a notification about the change in the arrival time at the reserved hotel or cancels the reserved hotel in accordance with the progress.

With this configuration, a necessary procedure is automatically performed in accordance with a schedule delay or the like. Therefore, the burden on the user U is reduced.

As the presentation of the tour support information TSI, the tour support system 14 makes a proposal to change the arrival time at the reserved hotel or to cancel the reserved hotel to the user U in accordance with the progress.

With this configuration, necessary measures are automatically proposed in accordance with a schedule delay or the like. The user U can take necessary measures on the basis of the proposal. Therefore, the burden on the user U is reduced.

The information processing system 1 includes the restaurant reservation system 30. The restaurant reservation system 30 makes a reservation for a restaurant that meets the desired conditions. The desired conditions of the hotel are input as the optional information.

With this configuration, a restaurant reservation is automatically made in accordance with the schedule of the custom tour CT. Therefore, the burden on the user U for reserving the restaurant is reduced.

The restaurant reservation system 30 extracts one or more restaurants on the basis of a position where the user U is predicted to stay in a meal time zone in which the user U is assumed to have a meal and desired conditions of the restaurant. The restaurant reservation system 30 reserves a restaurant selected by the user U from the extracted one or more restaurants in the meal time zone.

With this configuration, a restaurant in an appropriate location based on the schedule of the custom tour CT is extracted. The user U can select a favorite restaurant from the extracted one or more restaurants. Therefore, a restaurant in an appropriate location reflecting the preference of the user U is reserved.

The tour support system 14 makes a notification about the change in the arrival time at the reserved restaurant or cancels the reserved restaurant in accordance with the progress.

With this configuration, necessary measures are automatically proposed in accordance with a schedule delay or the like. Therefore, the burden on the user U is reduced.

As the presentation of the tour support information TSI, the tour support system 14 makes a proposal to change the arrival time at the reserved restaurant or to cancel the reserved restaurant to the user U in accordance with the progress.

With this configuration, necessary measures are automatically proposed in accordance with a schedule delay or the like. The user U can take necessary measures on the basis of the proposal. Therefore, the burden on the user U is reduced.

The information processing system 1 includes the navigation system 13. The navigation system 13 generates the navigation information NV to a destination due to the acquisition of travel start information of the user U.

With this configuration, navigation from the current spot SP to the next spot SP is automatically performed in conjunction with the travel of the user U. Therefore, the burden on the user U for obtaining the navigation information NV is reduced.

Due to the acquisition of spot specification information generated on the basis of the position information of the user U, the custom tour creation system 12 presents the spot introduction information SI of the current spot SP specified by the spot specification information to the user U as the tour support information TSI via the tour support system 14.

With this configuration, the appropriate spot introduction information SI corresponding to the spot SP being visited by the user U is provided to the user U.

The master schedule MS includes one or more spots SP in which a plurality of selectable sub-schedules SU are registered. The custom tour creation system 12 creates the custom tour CT by incorporating the sub-schedule SU input as the optional information from the user U into each of the one or more spots SP.

With this configuration, the sub-schedule SU to be registered in the spot SP can be set in accordance with the preference of the user U.

Due to the input of change information related to the schedule change from the user U during the execution of the custom tour CT, the custom tour creation system 12 changes the schedule of the custom tour CT after the input time of the change information on the basis of the change information

With this configuration, the user U can flexibly change the schedule of the custom tour CT.

The custom tour creation system 12 changes the schedule of the custom tour CT in accordance with the progress.

With this configuration, the schedule of the custom tour CT is automatically changed in accordance with the progress. Therefore, the user U can enjoy the tour without worrying about the progress.

The master schedule MS includes priority information related to the priority of each spot SP. As the presentation of the tour support information TSI, the tour support system 14 makes a proposal to delete one or more spots SP from a plurality of remaining spots SP on the basis of the priority information in accordance with the progress.

With this configuration, a proposal to delete the spot SP is automatically made in accordance with a schedule delay or the like. The proposal for deletion is made on the basis of the priority of each spot SP. Therefore, the satisfaction level of the custom tour CT after the correction is hardly greatly impaired.

The custom tour creation system 12 incorporates the side trip spot DSP input from the user U into the custom tour CT during the execution of the custom tour CT.

With this configuration, the user U can freely add the side trip spot DSP in accordance with the situation even during the execution of the custom tour CT. Therefore, the action of the user U is hardly restricted.

The tour support system 14 proposes one or more side trip spots DSP near the user U to the user U as the presentation of the tour support information TSI. The custom tour creation system 12 incorporates the side trip spot DSP selected by the user U from the one or more side trip spots DSP into the custom tour CT.

With this configuration, the side trip spot DSP is automatically proposed in accordance with the position information of the user U. Therefore, the user U can obtain useful information of the side trip spot DSP without actively searching. The user U can freely add the side trip spot DSP of interest. Therefore, the range of knowledge of the user U is widened, and a highly satisfactory tour is obtained.

The custom tour CT includes the time-limited event RP. As the presentation of the tour support information TSI, the tour support system 14 proposes deletion of one or more spots SP to the place where the event RP is held from the remaining plural spots SP to the user U in accordance with the progress.

With this configuration, a proposal to delete the spot SP is automatically made in accordance with a schedule delay or the like. The user U can easily create a schedule in time for the time when the event RP is held by deleting the spot SP on the basis of the proposal.

The tour support system 14 checks whether or not the time when the event is held can be changed in accordance with the progress as the presentation of the tour support information TSI. In a case where the time can be changed, the tour support system 14 proposes the change of the time to the user U as the presentation of the tour support information TSI. In a case where the time cannot be changed, the tour support system 14 proposes the cancellation of the event RP to the user U as the presentation of the tour support information TSI.

With this configuration, necessary measures are automatically proposed in accordance with a schedule delay or the like. The user U can take necessary measures on the basis of the proposal. Therefore, the burden on the user U is reduced.

The information processing system 1 includes the schedule extraction system 16 and the master schedule creation system 17. The schedule extraction system 16 extracts an actual schedule including a plurality of visit spots VSP, the time of stay at each visit spot VSP, and the route between the visit spots VSP from the action record during the tour. The master schedule creation system 17 determines a plurality of spots SP to be visited, the standard time of stay at each spot SP, and the standard route between the spots SP on the basis of correction information added by the creator CR (traveler) to the actual schedule, and creates the master schedule MS.

With this configuration, information such as the visit spot VSP and the time of stay is automatically extracted from the action record during the tour. Therefore, the master schedule MS can be easily created. Since the master schedule MS is created on the basis of the tour actually executed, the plan is reasonable and consistent as a whole. Therefore, it is possible to create the custom tour CT that does not impair the degree of freedom of individual travel while maintaining the convenience of a package tour.

The schedule extraction system 16 extracts an actual schedule on the basis of the action record associated with GPS data.

With this configuration, information such as the traffic line, the travel time, the travel speed, and the time of stay is acquired on the basis of the GPS data. Therefore, the position of the visit spot VSP, the time of stay at the visit spot VSP, the route between the visit spots VSP, the means of transportation, and the like are accurately estimated.

The action record includes captured data captured during the tour.

With this configuration, the visit spot VSP can be specified on the basis of a famous site and a historic site included in the subject.

The schedule extraction system 16 extracts, from the event database 18, one or more events held on the route of the tour on the day when the tour was executed. The schedule extraction system 16 extracts one or more event candidates from the extracted one or more events on the basis of the time of stay at the event venue estimated from the actual schedule. The schedule extraction system 16 determines, as the visit spot VSP, the event candidate selected by the creator CR from the extracted one or more event candidates.

With this configuration, an event can be extracted as the visit spot VSP.

The master schedule creation system 17 registers the spot introduction image SIM in the master schedule MS for each spot SP.

With this configuration, the image of the spot SP is easily recognized.

The schedule extraction system 16 extracts one or more photographs captured during the stay at the spot as candidate images from the action record. The schedule extraction system 16 determines the candidate image selected by the creator CR from the extracted one or more candidate images as the spot introduction image SIM.

With this configuration, the spot introduction image SIM can be generated on the basis of the action record.

The schedule extraction system 16 calculates the importance of each candidate image on the basis of the captured content. The schedule extraction system 16 presents each candidate image together with its importance to the creator CR.

With this configuration, the spot introduction image SIM can be easily selected on the basis of the importance.

The schedule extraction system 16 extracts one or more images related to the spot SP as candidate images from the network. The schedule extraction system 16 determines the candidate image selected by the creator CR from the extracted one or more candidate images as the spot introduction image SIM.

With this configuration, an appropriate image can be registered as the spot introduction image SIM in the spot SP with no captured data.

It should be noted that the effects described in the present specification are merely examples and are not limited, and other effects may be obtained.

Note that the present technology can also have the following configurations.

An information processing system comprising:
a custom tour creation system that creates a custom tour by incorporating optional information input from a user into a master schedule including a plurality of spots, a standard time of stay at each spot, and a standard route between the spots; and
a tour support system that monitors a progress of a custom tour being executed, presents tour support information based on the progress to the user, and supports an action of the user.

The information processing system according to (1), wherein

the tour support information includes navigation information between spots, spot introduction information of each spot, a warning related to a travel schedule between spots, and a proposal related to a change in a schedule of the custom tour.

The information processing system according to (1) or (2), wherein

the tour support system notifies the user of the tour support information by voice, and detects a response of the user to the tour support information on a basis of the voice of the user or a gesture to a wearable device worn by the user.

The information processing system according to any one of (1) to (3), further including

a hotel reservation system that makes a reservation for a hotel that meets desired conditions of a hotel input as the optional information.

The information processing system according to (4), wherein

the hotel reservation system extracts one or more hotels on the basis of a position of a final spot and desired conditions of the hotel, and reserves a hotel selected by the user from the one or more hotels.

The information processing system according to (4) or (5), wherein

the tour support system makes a notification about a change in an arrival time at a reserved hotel or cancels the reserved hotel in accordance with the progress.

The information processing system according to (4) or (5), wherein

as presentation of the tour support information, the tour support system makes a proposal to change an arrival time at a reserved hotel or to cancel the reserved hotel to the user in accordance with the progress.

The information processing system according to any one of (1) to (7), further including

a restaurant reservation system that makes a reservation for a restaurant that meets desired conditions of a restaurant input as the optional information.

The information processing system according to (8), wherein

the restaurant reservation system extracts one or more restaurants on the basis of a position where the user is predicted to stay in a meal time zone in which the user is assumed to have a meal and desired conditions of the restaurant, and reserves a restaurant selected by the user from the one or more restaurants in the meal time zone.

The information processing system according to claim (8) or (9), wherein

as presentation of the tour support information, the tour support system makes a notification about a change in an arrival time at a reserved restaurant or cancels the reserved restaurant in accordance with the progress.

The information processing system according to (8) or (9), wherein

the tour information distribution system makes a proposal to change an arrival time at a reserved restaurant or to cancel the reserved restaurant to the user in accordance with a progress of the custom tour being executed.

The information processing system according to any one of (1) to (11), further including

a navigation system that generates navigation information to a destination due to acquisition of travel start information of the user.

The information processing system according to any one of (1) to (12), wherein

due to acquisition of spot specification information generated on a basis of position information of the user, the custom tour creation system presents spot introduction information of a current spot specified by the spot specification information to the user as the tour support information via the tour support system.

The information processing system according to any one of (1) to (13), wherein
the master schedule includes one or more spots in which a plurality of selectable sub-schedules are registered, and
the custom tour creation system creates the custom tour by incorporating a sub-schedule input as the optional information from the user into each of the one or more spots.

The information processing system according to any one of (1) to (14), wherein

due to an input of change information related to a schedule change from the user during execution of the custom tour, the custom tour creation system changes a schedule of the custom tour after an input time of the change information on a basis of the change information.

The information processing system according to any one of (1) to (15), wherein

the custom tour creation system changes a schedule of the custom tour in accordance with the progress.

The information processing system according to any one of (1) to (16), wherein
the master schedule includes priority information related to priority of each spot, and
the tour support system makes, as presentation of the tour support information, a proposal to delete one or more spots from remaining plural spots on a basis of the priority information in accordance with the progress.

The information processing system according to any one of (1) to (17), wherein

the custom tour creation system incorporates a side trip spot input from the user into the custom tour during execution of the custom tour.

The information processing system according to (18), wherein
the tour support system proposes one or more side trip spots near the user to the user as presentation of the tour support information, and
the custom tour creation system incorporates a side trip spot selected by the user from the one or more side trip spots into the custom tour.

The information processing system according to any one of (1) to (19), wherein
the custom tour includes a time-limited event, and
the tour support system proposes, as presentation of the tour support information, deletion of one or more spots to a place where the event is held from remaining plural spots to the user in accordance with the progress.

The information processing system according to (20), wherein
as presentation of the tour support information, the tour support system
checks whether or not a time when the event is held can be changed in accordance with the progress,
in a case where the time can be changed, proposes a change of the time to the user, and
in a case where the time cannot be change, proposes cancellation of the event to the user.

The information processing system according to any one of (1) to (21), further comprising:
a schedule extraction system that extracts an actual schedule including a plurality of visit spots, a time of stay at each visit spot, and a route between the visit spots from an action record during a tour; and
a master schedule creation system that determines the plurality of spots to be visited, the standard time of stay at each spot, and the standard route between the spots on a basis of correction information added by a creator to the actual schedule, and creates the master schedule.

The information processing system according to (22), wherein

the schedule extraction system extracts the actual schedule on a basis of the action record associated with global positioning system (GPS) data.

The information processing system according to (23), wherein

the action record includes captured data captured during the tour.

The information processing system according to (23) or (24), wherein

the schedule extraction system extracts one or more events held on a route of the tour on a day when the tour is executed from an event database, extracts one or more event candidates from the one or more events on a basis of a time of stay at an event venue estimated from the actual schedule, and determines an event candidate selected by a creator from the one or more event candidates as the visit spot.

The information processing system according to any one of (22) to (25), wherein

the master schedule creation system registers a spot introduction image in the master schedule for each spot.

The information processing system according to (26), wherein

the schedule extraction system extracts one or more photographs taken during a stay at a spot from the action record as candidate images, and determines a candidate image selected by a creator from the one or more candidate images as the spot introduction image.

The information processing system according to (27), wherein

the schedule extraction system calculates importance of each candidate image on a basis of a captured content, and presents each candidate image to the creator together with the importance.

The information processing system according to (26), wherein

the schedule extraction system extracts one or more images related to the spot from a network as candidate images, and determines a candidate image selected by a creator from the one or more candidate images as the spot introduction image.

### REFERENCE SIGNS LIST

1 INFORMATION PROCESSING SYSTEM
11 TOUR INFORMATION DISTRIBUTION SYSTEM
12 CUSTOM TOUR CREATION SYSTEM
13 NAVIGATION SYSTEM
14 TOUR SUPPORT SYSTEM
18 EVENT DATABASE
20 HOTEL RESERVATION SYSTEM
30 RESTAURANT RESERVATION SYSTEM
CT CUSTOM TOUR
CR CREATOR (TRAVELER)
DSP SIDE TRIP SPOT
MS MASTER SCHEDULE
NV NAVIGATION INFORMATION
RP TIME-LIMITED EVENT
SI SPOT INTRODUCTION INFORMATION
SIM SPOT INTRODUCTION IMAGE
SP SPOT
SU SUB-SCHEDULE
TSI TOUR SUPPORT INFORMATION
U USER
VSP VISIT SPOT

What is claimed is:

1. An information processing system, comprising:
a custom tour creation system that creates a custom tour by incorporating optional information input from a user into a master schedule including a plurality of spots, a standard time of stay at each spot, and a standard route between the spots; and
a tour support system that monitors a progress of a custom tour being executed, presents tour support information based on the progress to the user, and supports an action of the user.

2. The information processing system according to claim 1, wherein
the tour support information includes navigation information between spots, spot introduction information of each spot, a warning related to a travel schedule between spots, and a proposal related to a change in a schedule of the custom tour.

3. The information processing system according to claim 1, wherein
the tour support system notifies the user of the tour support information by voice, and detects a response of the user to the tour support information on a basis of the voice of the user or a gesture to a wearable device worn by the user.

4. The information processing system according to claim 1, wherein
due to acquisition of spot specification information generated on a basis of position information of the user, the custom tour creation system presents spot introduction information of a current spot specified by the spot specification information to the user as the tour support information via the tour support system.

5. The information processing system according to claim 1, wherein
the master schedule includes one or more spots in which a plurality of selectable sub-schedules are registered, and
the custom tour creation system creates the custom tour by incorporating a sub-schedule input as the optional information from the user into each of the one or more spots.

6. The information processing system according to claim 1, wherein
due to an input of change information related to a schedule change from the user during execution of the custom tour, the custom tour creation system changes a schedule of the custom tour after an input time of the change information on a basis of the change information.

7. The information processing system according to claim 1, wherein
the custom tour creation system changes a schedule of the custom tour in accordance with the progress.

8. The information processing system according to claim 1, wherein
the master schedule includes priority information related to priority of each spot, and
the tour support system makes, as presentation of the tour support information, a proposal to delete one or more spots from remaining plural spots on a basis of the priority information in accordance with the progress.

9. The information processing system according to claim 1, wherein
the custom tour creation system incorporates a side trip spot input from the user into the custom tour during execution of the custom tour.

10. The information processing system according to claim 9, wherein
the tour support system proposes one or more side trip spots near the user to the user as presentation of the tour support information, and
the custom tour creation system incorporates a side trip spot selected by the user from the one or more side trip spots into the custom tour.

11. The information processing system according to claim 1, wherein
the custom tour includes a time-limited event, and
the tour support system proposes, as presentation of the tour support information, deletion of one or more spots to a place where the event is held from remaining plural spots to the user in accordance with the progress.

12. The information processing system according to claim 11, wherein
as presentation of the tour support information, the tour support system
checks whether or not a time when the event is held can be changed in accordance with the progress,
in a case where the time can be changed, proposes a change of the time to the user, and
in a case where the time cannot be change, proposes cancellation of the event to the user.

13. The information processing system according to claim 1, further comprising:
a schedule extraction system that extracts an actual schedule including a plurality of visit spots, a time of stay at each visit spot, and a route between the visit spots from an action record during a tour; and
a master schedule creation system that determines the plurality of spots to be visited, the standard time of stay at each spot, and the standard route between the spots on a basis of correction information added by a creator to the actual schedule, and creates the master schedule.

14. The information processing system according to claim 13, wherein
the schedule extraction system extracts the actual schedule on a basis of the action record associated with global positioning system (GPS) data.

15. The information processing system according to claim 14, wherein
the action record includes captured data captured during the tour.

16. The information processing system according to claim 14, wherein
the schedule extraction system extracts one or more events held on a route of the tour on a day when the tour is executed from an event database, extracts one or more event candidates from the one or more events on a basis of a time of stay at an event venue estimated from the actual schedule, and determines an event candidate selected by a creator from the one or more event candidates as the visit spot.

17. The information processing system according to claim 13, wherein
the master schedule creation system registers a spot introduction image in the master schedule for each spot.

18. The information processing system according to claim 17, wherein
the schedule extraction system extracts one or more photographs taken during a stay at a spot from the action record as candidate images, and determines a candidate image selected by a creator from the one or more candidate images as the spot introduction image.

19. The information processing system according to claim 18, wherein
the schedule extraction system calculates importance of each candidate image on a basis of a captured content, and presents each candidate image to the creator together with the importance.

20. The information processing system according to claim 17, wherein
the schedule extraction system extracts one or more images related to the spot from a network as candidate images, and determines a candidate image selected by a creator from the one or more candidate images as the spot introduction image.
